(19) United States
(12) Patent Application Publication
(10) Pub. No.: US 2026/0219685 A1
(43) Pub. Date: Jul. 30, 2026

(54) CONTROL METHOD FOR A ROBOT LAWNMOWER, IN PARTICULAR USABLE AS PART OF AN INITIALIZATION PROCEDURE

(71) Applicant: STIGA S.P.A. IN BREVE ANCHE ST. S.P.A., Castelfranco Veneto (TV) (IT)

(72) Inventors: Nicola DE PIERI, Casier (TV) (IT); Andrea MARANGON, Piazzola sul Brenta (PD) (IT); Alessandro MORGAN, Refrontolo (TV) (IT); Alexander SCHMIDT, Graz (AT); Michele SCAPIN, Cittadella (PD) (IT); Mauro CECCHETTO, San Martino di Lupari (PD) (IT)

(73) Assignee: STIGA S.P.A. IN BREVE ANCHE ST. S.P.A., Castelfranco Veneto (TV) (IT)

(21) Appl. No.: 19/143,544

(22) PCT Filed: Dec. 28, 2023
(86) PCT No.: PCT/IB2023/063334

§ 371 Date: Jun. 26, 2025

(30) Foreign Application Priority Data
Dec. 29, 2022 (IT) 102022000027198
Dec. 29, 2022 (IT) 102022000027207
Dec. 29, 2022 (IT) 102022000027213

(51) Int. Cl. G05D 1/648; A01D 34/00; A01D 101/00; G05D 1/248; G05D 1/661; G05D 105/15; G05D 107/20; G05D 109/10; G05D 111/50

(52) U.S. Cl. CPC G05D 1/6484; A01D 34/008; G05D 1/248; G05D 1/661; A01D 2101/00; G05D 2105/15; G05D 2107/23; G05D 2109/10; G05D 2111/52

(57) ABSTRACT

The application relates to a method for controlling the position of a robot. In a distance measurement step, starting from a temporary position and/or orientation of the robot with respect to a predetermined reference within a predetermined working area, a first distance is measured between a predefined point of the robot and a predefined point on a perimeter of the working area, the predefined point of the robot being placed at a predefined and non-zero distance with respect to a predefined rotation point of the robot. If the first distance is smaller than a threshold distance value, a rotation step of the robot is executed.

### FIELD OF THE INVENTION

The present invention relates to the field of self-driving robots, and in particular relates to a method for controlling the position and/or orientation of a robot and an associated robot.

### BACKGROUND OF THE INVENTION

Self-driving robots are typically employed to carry out activities inside buildings or outdoors. In particular, self-driving robots are known which integrate, for example, vacuum cleaners or lawnmowers.

Self-driving robot lawnmowers have been designed over the years to mow certain portions of lawn; currently, the known robot lawnmowers are capable of mowing certain portions of a lawn without the need for physical barriers delimiting the working area of the robot itself.

The robot lawnmowers integrate a various number of sensors, for example global satellite navigation sensors (e.g., GPS), accelerometers, compasses, gyroscopes, Hall-type sensors on wheels or tracks, encoders, and cameras; such sensors are intended to determine the position and/or orientation assumed by the robot lawnmower within the working area.

It is also known to use Kalman filters to predict the movement of the robot in the working area. The known Kalman filters are operatively fed with the signals from one or more of the aforementioned sensors; Kalman filters for robot lawnmowers output a position and/or orientation of the robot, an orientation of the robot and, sometimes, a measurement error.

Particular interest is given by the measurement error between the position and/or orientation of the self-driving robot and the position and/or orientation and/or actually assumed orientation by the robot itself.

The robot lawnmowers have a vehicle management control unit which can access a safety threshold datum which is compared with the measurement error.

When the vehicle management control unit electronically identifies a greater measurement error with respect to the safety threshold, an alarm signal is generated.

The alarm signal causes a stop of the self-driving robot, and—with specific reference to the field of robot lawnmowers—determines the need to start a re-initialization procedure to calibrate one or more of the sensors present on the robot.

The use of what is called the “3-step” procedure is also known, in which three steps of moving the robot along a predetermined direction, for example three steps of linear translation of the robot for a distance of 1 m, are executed in sequence.

Known technical solutions for controlling a robot lawnmower are disclosed in documents CN114859885A, CN102591342A, WO2018/214977A1, CN114690752A and CN114485635A.

The Applicant has observed that the robot lawnmowers are subject to a worsening of the positioning precision over time due, for example, to the slippage of the wheels or tracks, determined, for example, by slippage in turn generated by slope, or by wavy or wet surfaces. The conditions just identified are quite common in a lawn.

Furthermore, the “3-step” procedure is not always convenient to use, in particular where the robot lawnmower is operating in certain critical operating conditions.

The Applicant has observed that, despite the fact that in this section the main reference has been made to robot lawnmowers, the progressive worsening of the measurement precision is in any case typical also in the self-driving robots found operating inside buildings.

The object of the present disclosure is therefore to describe a method for controlling the position and/or orientation of a robot, and an associated robot, which allow greater operating flexibility when critical situations occur such as to determine the need for a re-initialization of the position and/or orientation assumed by the robot itself.

### Objective of the Invention

The object of the present disclosure is therefore to describe a method for controlling the position and/or orientation of a robot, and an associated robot, which allow greater operating flexibility when critical situations occur such as to determine the need for a re-initialization of the position and/or orientation assumed by the robot itself.

### SUMMARY OF THE INVENTION

The object of the present disclosure will now be disclosed in some of its main aspects, which are combinable with each other or with portions of the detailed description and/or claims.

In accordance with a first aspect, a method for controlling the position and/or orientation of a robot (100), preferably a robot lawnmower, is disclosed herein, comprising:
a storing step (1000), in which a first position and/or orientation datum (D(X0, Y0, φ0)) of said robot (100) positioned in a predetermined point (X0, Y0, φ0) of a predetermined working area (500) is stored electronically in an electronic memory (300), and in which the predetermined point (X0, Y0, φ0) is the point of a predetermined positional reference (200) for said robot (100);
an analysis step (1001), comprising an electronic analysis of a need to impose or reset a datum (D(X, Y, φ)) of temporary position and/or orientation (X, Y, φ) of said robot (100) with respect to said predetermined positional reference (200);
an access step (1002), comprising an electronic access to said electronic memory (300) and a subsequent extraction from said electronic memory (300) of said first position and/or orientation datum (D(X0, Y0, φ0));
a step of position and/or orientation imposition or reset (1003), in which, keeping the robot (100) at said positional reference (200), the datum (D(X, Y, φ)) of temporary position and/or orientation (X, Y, φ) of said robot (100) is forced to said first position and/or orientation datum (D(X0, Y0, φ0).

According to a further non-limiting aspect, in the position and/or orientation imposition or reset step (1003), if the robot (100) is not at said predetermined positional reference (200), and/or the temporary position and/or orientation (X, Y, φ) of said robot (100) does not correspond to that of the predetermined positional reference (200), the robot (100) is driven in movement to be positioned at said predetermined positional reference (200).

According to a further non-limiting aspect, said predetermined point (X0, Y0, φ0) is a point in which a charging station (400) for said robot (100) is present and/or the predetermined positional reference (200) corresponds to said charging station (400).

According to a further non-limiting aspect, the method comprises starting a working operating configuration, in which the robot (100) uses a tool thereof, optionally at least one among a mowing plate, a mowing bar, a vacuum cleaner, to execute a predetermined use activity, in particular a predetermined use activity for which it is primarily designed.

According to a further non-limiting aspect, the start of the working operating configuration comprises the activation, on said robot (100), of a drive motor, operatively connected with said tool.

According to a further non-limiting aspect, the method comprises a step of identifying the temporary position and/or orientation (X, Y, φ) of said robot (100) by means of a first positioning system and a second positioning system; preferably the step of identifying the temporary position and/or orientation (X, Y, φ) of said robot (100) by means of a first positioning system and a second positioning system being an identification step independently executed by said robot (100).

According to a further non-limiting aspect, the method comprises a compensation step of said temporary position and/or orientation (X, Y, φ) of said robot (100) by means of one among said first positioning system and said second positioning system; preferably the compensation step of said temporary position and/or orientation (X, Y, φ) of said robot (100) by means of one among said first positioning system and said second positioning system being a compensation step independently performed by said robot (100).

According to a further non-limiting aspect, said first positioning system and said second positioning system are independent positioning systems.

According to a further non-limiting aspect, said first positioning system is an inertial or kinematic calculation system associated with said wheels and/or rollers and/or tracks (102).

According to a further non-limiting aspect, said second positioning system is an external positioning system (800).

According to a further non-limiting aspect, at least the analysis step is executed during said working operating configuration.

According to a further non-limiting aspect, the analysis step temporarily interrupts said working operating configuration.

According to a further non-limiting aspect, the analysis step temporarily interrupts the activation of said drive motor.

According to a further non-limiting aspect, following the position and/or orientation imposition or reset step (1003), the method comprises a restart, substantially automated, of said working operating configuration.

According to a further non-limiting aspect, the method comprises a step of verifying a residual charge of at least one battery of said robot (100) and comprises a start of the working operating configuration and/or a stop of said working operating configuration according to said residual charge of said at least one battery.

According to a further non-limiting aspect, said charging station (400) has a known position and/or orientation, or said predetermined point (X0, Y0, φ0) is a point placed at a predefined distance with respect to a charging station (400) for said robot (100).

According to a further non-limiting aspect, the access step (1002) comprises an electronic access to said electronic memory (300) executed by said robot (100).

According to a further non-limiting aspect, the position and/or orientation imposition or reset step (1003) determines a storage of said first position and/or orientation datum (D(X0, Y0, φ0)) as temporary position and/or orientation datum (D(X, Y, φ)) of said robot (100).

According to a further non-limiting aspect, the operation of the robot (100) in motion to be positioned at said predetermined positional reference (200) comprises the robot (100) reaching the charging station (400).

According to a further non-limiting aspect, said reaching is determined and/or electronically identified by a coupling between electrical and/or magnetic contacts of the charging station (400) with electrical and/or magnetic contacts of said robot (100).

According to a further non-limiting aspect, the robot (100) reaching said predetermined positional reference (200) is determined by an alteration of an operating state of said robot (100) by means of a physical interaction step between said predetermined positional reference (200) and said robot (100).

According to a further non-limiting aspect, the method comprises a step of altering the operating state of said robot (100) when it reaches said charging station (400) and/or said predetermined positional reference (200).

According to a further non-limiting aspect, said electronic memory (300) is an electronic memory of the robot (100) or an electronic memory of said charging station (400), or is a memory (300) of a remote server with respect to the robot (100) and/or with respect to the charging station (400).

According to a further non-limiting aspect, the method comprises a step of operating access to said electronic memory of the charging station (400) by said robot (100).

According to a further non-limiting aspect, said predetermined working area (500) is defined based on a reference wire-free perimeter and/or said robot (100) is a wireless guide robot.

According to a further non-limiting aspect, the method comprises a movement step (1004), in which the robot (100) is moved within said predetermined working area (500), the movement step (1004) comprising an alteration of the datum (D(X, Y, φ)) of temporary position and/or orientation (X, Y, φ) of the robot (100).

According to a further non-limiting aspect, the alteration takes place in accordance with positioning data transmitted to said robot (100) by the external positioning system (800) and/or by said second positioning system and/or by positioning data determined by a movement motor unit (101) and/or by wheels and/or rollers and/or tracks (102) of said robot (100) and/or by a camera of said robot (100) and/or in relation to a delimiting wire of said predetermined working area (500).

According to a further non-limiting aspect, the method comprises a step of receiving positioning data towards said robot (100) from said external positioning system (800) and/or from said second positioning system.

According to a further non-limiting aspect, said external positioning system (800) and/or said second positioning system is a global satellite navigation system and, optionally, operating differentially with respect to a ground station (700) of known position and/or orientation.

According to a further non-limiting aspect, said global satellite navigation system is a system operating according to at least one among the GPS, Galileo, Glonass, Beidou, IRNSS, QZSS standard.

According to a further non-limiting aspect, the method according to the present disclosure comprises determining the position of said robot (100) with a system and/or a method for augmenting the performance of the global satellite navigation system.

According to a further non-limiting aspect, the method comprises a differential correction step of the position and/or orientation of the robot (100) for the datum (D(X, Y, φ)) of temporary position and/or orientation (X, Y, φ) of said robot (100), the differential correction step occurring by means of position data transmitted by a ground station (700) of known position and/or orientation.

According to a further non-limiting aspect, said augmenting system and/or method respectively comprise an RTK receiver and/or comprise the use of an RTK algorithm.

According to a further non-limiting aspect, the analysis step (1001) comprises an electronic calculation of a deviation between said datum (D(X, Y, φ)) of temporary position and/or orientation (X, Y, φ) of said robot (100) and a positioning datum of said robot (100) measured by means of an external positioning system (800) and/or said second positioning system, and in which if said deviation is greater with respect to a predetermined threshold value, the method comprises the start of said position and/or orientation imposition or reset step (1003).

According to a further non-limiting aspect, said deviation is a difference in absolute value between said datum (D(X, Y, φ)) of temporary position and/or orientation (X, Y, φ) of said robot (100) and a positioning datum of said robot (100) measured by means of the external positioning system (800) and/or said second positioning system.

According to a further non-limiting aspect, said threshold value is less than or equal to 100 cm, or less than or equal to 50 cm, or less than or equal to 25 cm, or less than or equal to 15 cm.

According to a further non-limiting aspect, if said deviation is greater with respect to a predetermined threshold value, the method comprises a movement step (1004), in which the robot (100) is moved within said predetermined working area (500) towards said charging station (400).

According to a further non-limiting aspect, the method comprises a step of determining a perimeter (1005), intended to define said predetermined working area (500), comprising a movement of the robot (100) along a first path (600) defined by the user starting from an initial point (601) in which said robot (100) assumes a known position and/or orientation.

According to a further non-limiting aspect, the determining step comprises a simultaneous storage of a plurality of path data (D(Xp, Yp, φp) during the continuation of said movement.

According to a further non-limiting aspect, the method comprises a step of storing said plurality of path data (D(Xp, Yp, φp)) in a non-volatile electronic memory, optionally in said electronic memory (300).

According to a further non-limiting aspect, the method comprises a preliminary movement step (1006) of the robot (100) within said predetermined working area (500), along a second path (602) defined by the user and starting from an initial point (601) towards said charging station (400) and a simultaneous storage of a plurality of path data (D(Xp, Yp, φp)) during the continuation of said preliminary movement.

According to a further non-limiting aspect, the method comprises in particular storing at least one destination datum (D(Xf, Yf, φf) corresponding to a path end point (Xf, Yf, φf) in which said charging station (400) is located.

According to a further non-limiting aspect, said destination datum comprises at least one azimuthal orientation angle of said charging station (400).

According to a further non-limiting aspect, said path end point (Xf, Yf, φf) corresponding to said predetermined point (X0, Y0, φ0).

According to a further non-limiting aspect, at least one among said predetermined point (X0, Y0, φ0), said first position and/or orientation datum (D(X0, Y0, φ0) or said temporary position and/or orientation datum (D(X, Y, φ)), or said path end point (Xf, Yf, φf) comprises at least one pair of Cartesian coordinates and, optionally, comprises an orientation angle on an azimuthal plane with respect to a reference direction.

According to a further non-limiting aspect, said azimuthal plane comprises at least a first direction and a second direction orthogonal to each other; said first and second direction orthogonal to each other being intended to determine said pair of Cartesian coordinates.

According to a further non-limiting aspect, said azimuthal plane comprising said first and said second direction and/or being a plane on which lies, at least locally, the ground on which, in use, said robot (100) moves.

According to a further non-limiting aspect, the method comprises at least one distance measurement step (2001), in which, starting from a temporary position and/or orientation (X, Y, φ) of said robot (100) with respect to said predetermined positional reference (200) within said predetermined working area (500), a first distance (70) is measured between a predefined point (103) of said robot (100) and a predefined point (P1) on a perimeter of said predetermined working area (500), and in which if said distance (70) is less than a threshold distance value (2002; 2006; 2009), the method comprises a rotation step (2003) of the robot (100) placing said predefined point (103) of said robot (100) at a second distance (70) with respect to said perimeter of said predetermined working area (500) and determining a rotation of said robot (100) from a first rotation angle ((φ1) of said robot (100) on the azimuthal plane to a second rotation angle (φ2) of said robot (100) on the azimuthal plane.

According to a further non-limiting aspect, if the second distance (70) is greater with respect to the first distance (70) and/or if said second distance (70) is greater than said threshold distance value (2002; 2006; 2009), the method comprises a movement step (2004; 2007; 2010) of said robot (100) along a direction (A) identified by said second rotation angle (φ2) of said robot (100) on an azimuthal plane.

According to a further non-limiting aspect, the method comprises a subsequent execution of at least one further electronic distance measurement step (2001), preferably a first and a second further distance measurement step (2005, 2008) and, if the second distance (70) is greater with respect to the first distance (70) and/or if said second distance (70) is greater than said threshold distance value (2002; 2006; 2009), a subsequent execution of at least one further movement step (2007; 2010), preferably a first and a second further movement step (2007; 2010), to determine said predetermined point (X0, Y0, φ0) of said predetermined working area (500), in particular to determine at least a first and a second distance coordinate with respect to said predetermined positional reference (200) and to determine an azimuthal orientation coordinate with respect to said predetermined positional reference (200).

In accordance with the present disclosure, a system is disclosed for controlling the position and/or orientation of a robot (100), preferably a robot lawnmower, comprising:
the robot (100),
an electronic memory (300) on which is stored (1000) a first position and/or orientation datum (D(X0, Y0, φ0) of said robot (100) when positioned in a predetermined point (X0, Y0, φ0) of a predetermined working area (500) where a predetermined positional reference (200) is situated, said electronic memory (300) being operatively accessible to said robot (100);
a data processing unit, configured to execute an electronic analysis (1001) of a need to impose or reset a datum (D(X, Y, φ) of temporary position and/or orientation (X, Y, φ) of said robot (100) with respect to said predetermined positional reference (200); in which
the data processing unit is configured to execute an electronic access (1002) to said electronic memory (300) and to subsequently extract, from said electronic memory (300), said first position and/or orientation datum (D(X0, Y0, φ0));
the data processing unit being configured to operate a position and/or orientation imposition or reset (1003), comprising a maintenance of the robot (100) at said predetermined positional reference (200), and a forcing of said datum (D(X, Y, φ)) of temporary position and/or orientation (X, Y, φ) of said robot (100) to said first position and/or orientation datum (D(X0, Y0, φ0)).

According to a further non-limiting aspect, the data processing unit is configured to operate a position and/or orientation imposition or reset in which if the robot (100) is not at said predetermined positional reference (200), and/or the temporary position and/or orientation (X, Y, φ) of said robot (100) does not correspond to that of the predetermined positional reference (200), a movement control of said robot (100) to position it at said predetermined positional reference (200).

According to a further non-limiting aspect, the data processing unit comprises a data processing unit (104) of said robot and/or a data processing unit of a charging station (400).

According to a further non-limiting aspect, said predetermined point (X0, Y0, φ0) is a point in which the charging station (400) for said robot (100) is present and/or in which the predetermined positional reference (200) corresponds to said charging station (400), said charging station (400) having a known position and/or orientation, or is a point situated at a predefined distance with respect to said charging station (400).

According to a further non-limiting aspect, the system is configured to determine a start of a working operating configuration, in which the robot (100) uses a tool thereof, optionally at least one among a mowing plate, a mowing bar, a vacuum cleaner, to execute a predetermined use activity, in particular a predetermined use activity for which it is primarily designed.

According to a further non-limiting aspect, the start of the working operating configuration comprises the activation, on said robot (100), of a drive motor, operatively connected with said tool.

According to a further non-limiting aspect, the robot (100) is configured to identify, preferably independently, the temporary position and/or orientation (X, Y, φ) thereof by means of a first positioning system and a second positioning system.

According to a further non-limiting aspect, the robot (100) is configured to compensate, preferably independently, said temporary position and/or orientation (X, Y, φ) by means of one among said first positioning system and said second positioning system.

According to a further non-limiting aspect, said first positioning system and said second positioning system are independent positioning systems.

According to a further non-limiting aspect, said first positioning system is an inertial or kinematic calculation system associated with said wheels and/or rollers and/or tracks (102).

According to a further non-limiting aspect, said second positioning system is an external positioning system (800).

According to a further non-limiting aspect, at least the analysis is executed during said working operating configuration.

According to a further non-limiting aspect, the system is configured to determine the temporary interruption of said working operating configuration during said analysis.

According to a further non-limiting aspect, the system, during said analysis, is configured to temporarily interrupt the activation of said drive motor.

According to a further non-limiting aspect, following said position and/or orientation imposition or reset (1003), the system is configured to execute a restart, substantially automated, of said working operating configuration.

According to a further non-limiting aspect, the system is configured to verify a residual charge of at least one battery of said robot (100) and is configured to start a working operating configuration and/or a stop of said working operating configuration according to said residual charge of said at least one battery.

According to a further non-limiting aspect, the electronic access (1002) to said electronic memory (300) is executed by said robot (100).

According to a further non-limiting aspect, said position and/or orientation imposition or reset (1003) determines a storage of said first position and/or orientation datum (D(X0, Y0, φ0)) as temporary position and/or orientation datum (D(X, Y, φ)) of said robot (100).

According to a further non-limiting aspect, the robot (100) and, preferably, the system, is configured to electronically identify said robot (100) reaching the charging station (400), when there is a coupling between electrical and/or magnetic contacts of the charging station (400) with electrical and/or magnetic contacts of said robot (100), or the robot (100) and, preferably, the system, is configured to electronically detect said robot (100) reaching the predetermined positional reference (200), when there is a physical interaction between said predetermined positional reference (200) and said robot (100).

According to a further non-limiting aspect, reaching said predetermined positional reference (200) and/or said charging station (400) causing an alteration of an operating state of said robot (100).

According to a further non-limiting aspect, said coupling is a direct electrical and/or contact coupling or an electromagnetic coupling without direct contact between the magnetic contacts of the charging station (400) and the magnetic contacts of said robot (100).

According to a further non-limiting aspect, the data processing unit is configured to determine a movement (1004) of the robot (100) within said predetermined working area (500), the movement (1004) comprising an alteration of the datum (D(X, Y, φ)) of temporary position and/or orientation (X, Y, φ) of the robot (100).

According to a further non-limiting aspect, the alteration takes place in accordance with positioning data transmitted to said robot (100) by an external positioning system (800) and/or by said second positioning system and/or by positioning data determined by a movement motor unit (101) and/or by wheels and/or rollers and/or tracks (102) of said robot (100) and/or by a camera of said robot (100) and/or in relation to a delimiting wire of said predetermined working area (500).

According to a further non-limiting aspect, the robot (100) is configured to receive positioning data from said external positioning system (800) and/or from said second positioning system, and in which said external positioning system is a global satellite navigation system.

According to a further non-limiting aspect, a position and/or orientation control system of a robot (100) is configured to operate with a technique of augmenting the performance provided by said global satellite navigation system.

According to a further non-limiting aspect, the robot (100) comprises a position and/or orientation control system specifically configured to operate with a differential correction of the datum (D(X, Y, φ)) of temporary position and/or orientation (X, Y, φ) of said robot (100) with a ground station (700) of known position and/or orientation.

According to a further non-limiting aspect, said ground station (700) lies in a fixed position.

According to a further non-limiting aspect, said ground station (700) is substantially positioned inside said predetermined working area (500).

According to a further non-limiting aspect, the electronic analysis (1001) comprises an electronic calculation of a deviation between said datum (D(X, Y, φ)) of temporary position and/or orientation (X, Y, φ) of said robot (100) and a positioning datum of said robot (100) measured by means of an external positioning system (800) and/or by said second positioning system.

According to a further non-limiting aspect, if said deviation is greater with respect to a predetermined threshold value, the data processing unit is configured to start said position and/or orientation imposition or reset (300).

According to a further non-limiting aspect, if said deviation is greater with respect to a predetermined threshold value, the data processing unit is configured to determine a movement (1004) of the robot (100) within said predetermined working area (500) towards said charging station (400).

According to a further non-limiting aspect, the system is configured to electronically determine a perimeter (1005), to define said predetermined working area (500), by moving the robot (100) along a first path (600) defined by the user starting from an initial point (601) having a known position and/or orientation and a simultaneously storage of a plurality of path data (D(Xp, Yp, φp)) during the continuation of said movement.

According to a further non-limiting aspect, said system is configured to store said plurality of path data (D(Xp, Yp, φp)) in a non-volatile auxiliary electronic memory, optionally in said electronic memory (300).

According to a further non-limiting aspect, the system is configured to determine a preliminary movement step (1006) of the robot (100) within said predetermined working area (500), along a second path (602) defined by the user and starting from an initial point (601) towards said charging station (400) and a simultaneous storage of a plurality of path data (D(Xp, Yp, φp)) during the continuation of said preliminary movement.

According to a further non-limiting aspect, said system is configured to determine the storage of at least one destination datum (D(Xf, Yf, φf)) corresponding to a path end point (Xf, Yf, φf) in which said charging station (400) is located.

According to a further non-limiting aspect, said destination datum comprises at least one azimuthal orientation angle of said charging station (400).

According to a further non-limiting aspect, said path end point (Xf, Yf, φf) corresponding to said predetermined point (X0, Y0, φ0).

According to a further non-limiting aspect, said data processing unit is configured to execute or cause the execution of an electronic distance measurement (2001), in which, starting from a temporary position and/or orientation (X, Y, φ) of said robot (100) with respect to said predetermined positional reference (200) within said predetermined working area (500), a first distance (70) is measured between a predefined point (103) of said robot (100) and a predefined point (P1) on a perimeter of said predetermined working area (500).

According to a further non-limiting aspect, if said distance (70) is less than a threshold distance value (2002; 2006; 2009), the robot (100) is configured to execute a rotation (2003) placing said predefined point (103) of said robot (100) at a second distance (70) with respect to said perimeter of said predetermined working area (500), said rotation determining a rotation of said robot (100) from a first rotation angle (φ1) of said robot (100) on the azimuthal plane to a second rotation angle (φ2) of said robot (100) on an azimuthal plane.

According to a further non-limiting aspect, if said distance (70) is less than a threshold distance value (2002; 2006; 2009), the system is configured to make the robot (100) rotate (2003), placing said predefined point (103) of said robot (100) at a second distance (70) with respect to said perimeter of said predetermined working area (500), said rotation determining a rotation of said robot (100) from a first rotation angle (φ1) of said robot (100) on the azimuthal plane to a second rotation angle (φ2) of said robot (100) on an azimuthal plane.

According to a further non-limiting aspect, the system and/or the robot (100), if the second distance (70) is greater with respect to the first distance (70) and/or if said second distance (70) is greater than said threshold distance value (2002; 2006; 2009), it is configured to perform a movement (2004; 2007; 2010) along a direction (A) identified by said second rotation angle (φ2) of said robot (100) on an azimuthal plane.

According to a further non-limiting aspect, the system and/or the robot (100) is configured to execute at least one further distance measurement step (2001), preferably a first and a second further distance measurement step (2005, 2008) and in which the robot (100), if the second distance (70) is greater with respect to the first distance (70) and/or if said second distance (70) is greater than said threshold distance value (2002; 2006; 2009), is configured to subsequently execute at least one further movement (2007; 2010), preferably a first and a second further movement (2007; 2010), to determine said predetermined point (X0, Y0, φ0) of said predetermined working area (500), in particular to determine at least a first and a second distance coordinate with respect to said predetermined positional reference (200) and to determine an azimuthal orientation coordinate with respect to said predetermined positional reference (200).

In accordance with the present disclosure, a robot (100) is further disclosed, preferably a robot lawnmower, comprising a data processing unit (104) configured to access an electronic memory (300) on which is stored (1000) a first position and/or orientation datum (D(X0, Y0, φ0) of said robot (100) when positioned in a predetermined point (X0, Y0, φ0) of a predetermined working area (500) where a predetermined positional reference (200) is situated, said electronic memory (300) being operatively accessible to said robot (100);
in which the data processing unit (104) is configured to execute an electronic analysis (1001) of a need to impose or reset a datum (D(X, Y, φ)) of temporary position and/or orientation (X, Y, φ) of said robot (100) with respect to said predetermined positional reference (200) and/or is configured to receive electronic data concerning said electronic analysis (1001) of the need to impose or reset said datum (D(X, Y, φ)) of temporary position and/or orientation (X, Y, φ) of said robot (100) with respect to said predetermined positional reference (200);
the data processing unit (104) being configured to execute an electronic access (1002) to said electronic memory (300) and to subsequently extract, from said electronic memory (300), said first position and/or orientation datum (D(X0, Y0, φ0));
the data processing unit (104) being configured to operate a position and/or orientation imposition or reset (1003), and to cause a maintenance of the robot (100) at said predetermined positional reference (200), and forcing said datum (D(X, Y, φ)) of temporary position and/or orientation (X, Y, φ) of said robot (100) to said first position and/or orientation datum (D(X0, Y0, φ0).

According to a further non-limiting aspect, the data processing unit (104) being configured to operate a position and/or orientation imposition or reset (1003) in which if the robot (100) is not at said predetermined positional reference (200), and/or the temporary position and/or orientation (X, Y, φ) of said robot (100) does not correspond to that of the predetermined positional reference (200), to cause a movement of said robot (100) to position it at said predetermined positional reference (200).

According to a further non-limiting aspect, said predetermined point (X0, Y0, φ0) is a point in which the charging station (400) for said robot (100) is present and/or in which the predetermined positional reference (200) corresponds to said charging station (400), said charging station (400) having a known position and/or orientation, or is a point situated at a predefined distance with respect to said charging station (400).

According to a further non-limiting aspect, said electronic memory (300) is a memory of said robot (100), and the electronic access (1002) is an electronic access to said memory (300) executed by said data processing unit (104).

According to a further non-limiting aspect, said position and/or orientation imposition or reset (1003) determines a storage of said first position and/or orientation datum (D(X0, Y0, φ0)) as temporary position and/or orientation datum (D(X, Y, φ)) of said robot (100).

According to a further non-limiting aspect, the robot (100) is configured to activate a working operating configuration, in which the robot (100) uses a tool thereof, optionally at least one among a mowing plate, a mowing bar, a vacuum cleaner, to execute a predetermined use activity, in particular a predetermined use activity for which it is primarily designed.

According to a further non-limiting aspect, the robot (100) comprises a drive motor operatively connected with said tool and the activation of the working operating configuration comprises the activation of the drive motor.

According to a further non-limiting aspect, at least the analysis is executed during said working operating configuration.

According to a further non-limiting aspect, the robot (100) is configured to temporarily interrupt said working operating configuration during said analysis.

According to a further non-limiting aspect, during said analysis, the robot (100) is configured to temporarily interrupt the activation of said drive motor.

According to a further non-limiting aspect, following said position and/or orientation imposition or reset (1003), the robot (100) is configured to execute a restart, substantially automated, of said working operating configuration.

According to a further non-limiting aspect, the robot (100) is configured to verify a residual charge of at least one battery thereof and is configured to start a working operating configuration and/or a stop of said working operating configuration according to said residual charge of said at least one battery.

According to a further non-limiting aspect, the robot (100) comprises electrical and/or magnetic contacts and is configured to electronically identify reaching the charging station (400) when there is a coupling between electrical and/or magnetic contacts of the charging station (400) with electrical and/or magnetic contacts of said robot (100).

According to a further non-limiting aspect, the robot (100) is configured to electronically identify the robot (100) reaching the predetermined positional reference (200), when a physical interaction occurs between the predetermined positional reference (200) and the robot (100).

According to a further non-limiting aspect, reaching said predetermined positional reference (200) and/or said charging station (400) causing an alteration of an operating state of said robot (100).

According to a further non-limiting aspect, the data processing unit is configured to determine a movement (1004) of the robot (100) within said predetermined working area (500), the movement (1004) comprising an alteration of the datum (D(X, Y, φ)) of temporary position and/or orientation (X, Y, φ) of the robot (100), in which the alteration takes place according to positioning data transmitted to said robot (100) by an external positioning system (800) and/or by said second positioning system and/or by positioning data determined by a movement motor unit (101) and/or by wheels and/or rollers and/or tracks (102) of said robot (100) and/or by a camera of said robot (100) and/or in relation to a delimiting wire of said predetermined working area (500).

According to a further non-limiting aspect, the robot (100) is configured to receive positioning data from said external positioning system (800) and/or from said second positioning system, and in which said external positioning system is a global satellite navigation system and, optionally, operating differentially with respect to a ground station (700) of known position and/or orientation,
and/or the robot (100) comprises a position and/or orientation control system specifically configured to operate with a differential correction of the datum (D(X, Y, φ)) of temporary position and/or orientation (X, Y, φ) of said robot (100) with a ground station (700) of known position and/or orientation.

According to a further non-limiting aspect, the robot (100) is configured to electronically determine a perimeter (1005), to define said predetermined working area (500), moving, in use, along a first path (600) defined by the user starting from an initial point (601) having a known position and/or orientation and a simultaneous storage of a plurality of path data (D(Xp, Yp, φp)) during the continuation of said movement.

According to a further non-limiting aspect, the robot (100) is configured to store said plurality of path data (D(Xp, Yp, φp) in a non-volatile auxiliary electronic memory, optionally in said electronic memory (300). According to a further non-limiting aspect, the robot (100) is configured to be preliminarily moved (1006) within said predetermined working area (500), along a second path (602) defined by the user and starting from an initial point (601) towards said charging station (400) and a simultaneous storage of a plurality of path data (D(Xp, Yp, φp)) during the continuation of said preliminary movement.

According to a further non-limiting aspect, the robot (100) is configured to determine the storage of at least one destination datum (D(Xf, Yf, φf)) corresponding to a path end point (Xf, Yf, φf) in which said charging station (400) is located.

According to a further non-limiting aspect, the robot (100), if the second distance (70) is greater with respect to the first distance (70) and/or if said second distance (70) is greater than said threshold distance value (2002; 2006; 2009), it is configured to perform a movement (2004; 2007; 2010) along a direction (A) identified by said second rotation angle (φ2) of said robot (100) on an azimuthal plane.

According to a further non-limiting aspect, the robot (100) is configured to execute at least one further distance measurement step (2001), preferably a first and a second further distance measurement step (2005, 2008) and in which the robot (100), if the second distance (70) is greater with respect to the first distance (70) and/or if said second distance (70) is greater than said threshold distance value (2002; 2006; 2009), is configured to subsequently execute at least one further movement (2007; 2010), preferably a first and a second further movement (2007; 2010), to determine said predetermined point (X0, Y0, φ0) of said predetermined working area (500), in particular to determine at least a first and a second distance coordinate with respect to said predetermined positional reference (200) and to determine an azimuthal orientation coordinate with respect to said predetermined positional reference (200).

In accordance with the present disclosure, a method is further disclosed for controlling the position of a robot (100), preferably a robot lawnmower, comprising:
a distance measurement step (2001), in which, starting from a temporary position and/or orientation (X, Y, φ) of said robot (100) with respect to a predetermined reference (200) within a predetermined working area (500), a first distance (70) between a predefined point (103) of said robot (100) and a perimeter (600) of said predetermined working area (500) is measured, in which
if said first distance (70) is less than a threshold distance value (2002; 2006; 2009), the method comprises a rotation step (2003) of the robot (100), placing said predefined point (103) of said robot (100) at a second distance (70) with respect to said perimeter (600) of said predetermined working area (500), said rotation step (2003) comprising an actuation of a movement motor unit (101) of the robot (100) acting on its wheels and/or rollers and/or tracks (102) and determining a rotation from a first rotation angle (φ1) of said robot (100) on an azimuthal plane to a second rotation angle (φ2) of said robot (100) on the azimuthal plane.

According to a further non-limiting aspect, the first distance (70) and/or the second distance (70) with respect to said perimeter (600) are respectively a first distance (70) and/or a second distance (70) with respect to a predefined point (P1) on the perimeter (600).

According to a further non-limiting aspect, the predefined point (P1) on the perimeter (600) of said predetermined working area (500) is a point (P1) at a minimum distance with respect to said predefined point (103) of said robot (100) and in which the first distance (70) and/or the second distance (70) between the predefined point (103) of said robot (100) and the predefined point (P1) is a distance calculated on a direction orthogonal to a local tangent to said predefined point (P1) of said perimeter (600).

According to a further non-limiting aspect, if the second distance (70) is greater with respect to the first distance (70) and/or if said second distance (70) is greater than said threshold distance value (2002; 2006; 2009), the method comprises a movement step (2004; 2007; 2010) of said robot (100) along a direction (A) identified by said second rotation angle (φ2) of said robot (100) on an azimuthal plane.

According to a further non-limiting aspect, the movement step (2004; 2007; 2010) automatically ending when the robot (100) has travelled at least a predefined translation distance.

According to a further non-limiting aspect, said movement is a substantially axial movement.

According to a further non-limiting aspect, said translation distance is at least equal to 20 cm or 30 cm or 40 cm or 50 cm.

According to a further non-limiting aspect, the actuation of the movement motor unit (101) comprises an actuation of at least one among a first movement motor and a second movement motor.

According to a further non-limiting aspect, the actuation of the at least one among a first movement motor and a second movement motor is an activation of the first movement motor independently with respect to the second movement motor and/or comprises an activation of the first movement motor and the second movement motor simultaneously or alternatively, and/or in a concordant or discordant sense, and/or at a same or different rotation speed.

According to a further non-limiting aspect, the actuation of the first movement motor determines a rotation of at least one among the wheels and/or rollers and/or tracks (102) positioned on a first side of the robot (100) and the actuation of the second movement motor (100) determines a rotation of at least one among the wheels and/or rollers and/or tracks (102) positioned on a second side of the robot (100).

According to a further non-limiting aspect, the method comprises a step of actuating a drive motor, positioned on the robot (100) and operatively connected with a tool of the robot (100).

According to a further non-limiting aspect, the step of actuating the drive motor is a step independent of the actuation of the movement motor unit (101).

According to a further non-limiting aspect, the rotation is centred on a predefined rotation point (71) of said robot (100) placed at a predetermined and non-zero distance (K) with respect to said predefined point (103) of the robot (100).

According to a further non-limiting aspect, said predefined point (103) of the robot (100) comprises at least one among an antenna configured to receive a positioning signal of the robot (100), preferably a satellite positioning signal of the robot (100), and/or a unit for receiving a positioning signal of the robot (100).

According to a further non-limiting aspect, the positioning signal comprises positioning data transmitted to said robot (100) by an external positioning system (800) and/or by said second positioning system.

According to a further non-limiting aspect, the movement step (2004; 2007; 2010) of said robot (100) along the direction (A) comprises a linear translation for a predefined translation distance, and is followed by a further distance measurement step (2001).

According to a further non-limiting aspect, said predefined translation distance being optionally determined by means of said positioning signal.

According to a further non-limiting aspect, the distance measurement step (2001) comprises a reception of said positioning signal, in particular of said satellite positioning signal, of said robot (100).

According to a further non-limiting aspect, the reception of said positioning signal determining a reception of at least one datum (D(X, Y, φ)) of temporary position and/or orientation (X, Y, φ) of said robot (100). According to a further non-limiting aspect, the distance measurement step (2001) comprises a calculation of said first distance (70) and of said second distance (70) by means of said positioning signal.

According to a further non-limiting aspect, said datum (D(X, Y, φ)) of temporary position and/or orientation (X, Y, φ) of said robot (100) being updated at least when said robot (100) lies at said second distance (70).

According to a further non-limiting aspect, if the second distance (70) is smaller with respect to the first distance (70) and/or if said second distance (70) is smaller than said threshold distance value (2002; 2006; 2009), the method comprises a rotation of said robot (100) by said second rotation angle (φ2) of said robot (100) on an azimuthal plane to at least one further rotation angle ((φ3) of said robot (100) on the azimuthal plane. According to a further non-limiting aspect, the method subsequently comprises a further distance measurement step (2001).

According to a further non-limiting aspect, the first rotation angle (φ1) and/or the second rotation angle (φ2) and/or the third rotation angle ((φ3) is defined with respect to a predefined and constant reference direction.

According to a further non-limiting aspect, if following said rotation of said robot (100) from said second rotation angle ((φ2) of said robot (100) on an azimuthal plane to at least one further rotation angle ((φ3) of said robot (100) on the azimuthal plane or if following a complete rotation of said robot on said azimuthal plane, the distance of the robot (100) from said perimeter (600) is always smaller with respect to said threshold distance value (2002; 2006; 2009), the method comprises a stop of said robot (100) and the transmission of an alarm signal and/or a definition and/or a storage of a threshold distance value (2002; 2006; 2009) lower than the previous one.

According to a further non-limiting aspect, the step of moving (2004; 2007; 2010) said robot (100) along a direction (A) comprises an electronic calculation of a distance travelled by said robot (100) by means of an inertial or kinematic calculation system associated with said wheels and/or rollers and/or tracks (102) and/or comprises an electronic calculation of a distance travelled by said robot (100) by means of the positioning signal received from said antenna and/or receiving unit of a positioning signal.

According to a further non-limiting aspect, the step of identifying the temporary position and/or orientation (X, Y, φ) of said robot (100) by means of a first positioning system and a second positioning system occurs at least in conjunction with said movement step (2004; 2007; 2010).

According to a further non-limiting aspect, the method comprises an electronic calculation step of a difference between the distance travelled by said robot (100) calculated by means of said inertial or kinematic calculation system and the distance travelled by said robot (100) by means of the positioning signal received from said antenna and/or unit for receiving a positioning signal, and/or by means of said external positioning system (800) and/or by said second positioning system.

According to a further non-limiting aspect, the method comprises a transmission of an alarm signal when said difference is in absolute value greater with respect to a predetermined critical difference threshold.

In accordance with the present disclosure, a robot (100) is further disclosed, preferably an automatic-driving robot lawnmower, comprising:
a movement motor unit (101);
wheels and/or rollers and/or tracks (102), connected to said movement motor unit (101) and configured to determine a movement of the robot (100);
a data processing unit (104), configured to perform an electronic measurement (2001) of a distance between a temporary position and/or orientation (X, Y, φ) of said robot (100) with respect to a predetermined reference (200) within a predetermined working area (500) and determine a first distance (70) between a predefined point (103) of said robot (100) and a perimeter (600) of said predetermined working area (500), in which
said data processing unit (104) is configured to calculate a difference between said first distance (70) and a threshold distance value (2002; 2006; 2009),
and in which, if said distance (70) is less than a threshold distance value (2002; 2006; 2009), the data processing unit (104) is configured to drive said movement motor unit (101) so as to determine, by means of said wheels and/or rollers and/or tracks (102), a rotation (2003) of the robot (100), placing said predefined point (103) of said robot (100) at a second distance (70) with respect to said perimeter (600) of said predetermined working area (500), said rotation step (2003) determining a rotation of said robot (100) from a first rotation angle ((φ1) of said robot (100) on an azimuthal plane to a second rotation angle ((φ2) of said robot (100) on the azimuthal plane.

According to a further non-limiting aspect, if the second distance (70) is greater with respect to the first distance (70) and/or if said second distance (70) is greater than said threshold distance value (2002; 2006; 2009), the data processing unit (104) is configured to drive said movement motor unit (101) so as to determine, by means of said wheels and/or rollers and/or tracks (102), a movement (2004; 2007; 2010) of said robot (100) along a direction (A) identified by said second rotation angle (φ2) of said robot (100) on an azimuthal plane.

According to a further non-limiting aspect, said data processing unit (104) being configured to automatically determine an end of the movement (2004; 2007; 2010) when the robot (100) has travelled at least a predefined translation distance.

According to a further non-limiting aspect, the rotation is centred on a predefined rotation point (71) of said robot (100) placed at a predetermined and non-zero distance (K) with respect to said predefined point (103) of the robot (100).

According to a further non-limiting aspect, the movement motor unit (101) comprises at least a first movement motor and a second movement motor.

According to a further non-limiting aspect, said first movement motor and said second movement motor are electric motors.

According to a further non-limiting aspect, the robot (100) is configured to control the first movement motor and the second movement motor independently and/or to control the first movement motor and the second movement motor with a simultaneous or alternative activation, and/or in a concordant or discordant sense, and/or at a same or different rotation speed.

According to a further non-limiting aspect, the first movement motor is operatively connected with at least one among the wheels and/or rollers and/or tracks (102) positioned on a first side of the robot (100) and the second movement motor is operatively connected with at least one among the wheels and/or rollers and/or tracks (102) positioned on a second side of the robot (100). According to a further non-limiting aspect, the first side of the robot (100) and the second side of the robot (100) are respectively a left side and a right side.

According to a further non-limiting aspect, the robot (100) comprises a drive motor, operatively connected with a tool.

According to a further non-limiting aspect, the drive motor is an electric motor.

According to a further non-limiting aspect, the drive motor is configured to be controlled independently from the movement motor unit (101).

According to a further non-limiting aspect, said tool is at least one among a mowing plate, a mowing bar, or a vacuum cleaner.

According to a further non-limiting aspect, the predefined point (103) lies in a position substantially opposite the position in which said rotation point (71) lies.

According to a further non-limiting aspect, said predefined point (103) of the robot (100) comprises at least one among an antenna configured to receive a positioning signal of the robot (100), preferably a satellite positioning signal of the robot (100), and/or a unit for receiving a positioning signal of the robot (100).

According to a further non-limiting aspect, the positioning signal comprises positioning data transmitted to said robot (100) by an external positioning system (800) and/or by said second positioning system.

According to a further non-limiting aspect, the data processing unit (104) is configured to determine a movement (2004; 2007; 2010) of said robot (100) along the direction (A) comprising a linear translation for a predefined translation distance, and to electronically calculate a further electronic distance measurement (2001).

According to a further non-limiting aspect, the predefined translation distance being optionally determined by means of said positioning signal.

According to a further non-limiting aspect, the robot (100) further comprises a receiver for positioning signals configured to receive said positioning signal, in particular said satellite positioning signal, of said robot (100).

According to a further non-limiting aspect, the receiver is configured to receive and/or decode at least one datum (D(X, Y, φ)) of temporary positioning (X, Y, φ) of said robot (100), said datum (D(X, Y, φ)) being extracted from said positioning signal, in particular said satellite positioning signal.

According to a further non-limiting aspect, said electronic measurement (2001) comprises an electronic calculation of said first distance (70) and of said second distance (70) by means of said positioning signal.

According to a further non-limiting aspect, said datum (D(X, Y, φ)) of temporary position (X, Y, φ) of said robot (100) is updated at least when said robot (100) lies at said second distance (70).

According to a further non-limiting aspect, if the second distance (70) is smaller with respect to the first distance (70) and/or if said second distance (70) is smaller than said threshold distance value (2002; 2006; 2009), the data processing unit (104) is configured to drive said movement motor unit (101) so as to determine, by means of said wheels and/or rollers and/or tracks (102), a rotation of said robot (100) from said second rotation angle (φ2) of said robot (100) on an azimuthal plane to at least one further rotation angle (φ3) of said robot (100) on the azimuthal plane.

According to a further non-limiting aspect, the data processing unit (104) is configured to cause the execution of a further distance measurement step (2001) following said rotation.

According to a further non-limiting aspect, if following said rotation of said robot (100) from said second rotation angle (φ2) of said robot (100) on an azimuthal plane to at least one further rotation angle (φ3) of said robot (100) on the azimuthal plane or if following a complete rotation of said robot on said azimuthal plane, the distance of the robot (100) from said perimeter (600) is always smaller with respect to said threshold distance value (2002; 2006; 2009), the data processing unit (104) is configured to determine a stop of said robot (100) and to transmit an alarm signal and/or a definition and/or a storage of a threshold distance value (2002; 2006; 2009) lower with respect to the previous one.

According to a further non-limiting aspect, the robot (100) comprises an inertial or kinematic calculation system associated with said wheels and/or rollers and/or tracks (102) and the data processing unit (104) is configured to execute an electronic calculation of a distance travelled by said robot (100) by means of an inertial or kinematic calculation system associated with said wheels and/or rollers and/or tracks (102), and/or the data processing unit (104) is configured to execute an electronic calculation of a distance travelled by said robot (100) by means of the positioning signal received from said antenna and/or unit for receiving a positioning signal to execute the movement (2004; 2007; 2010) of said robot (100) along a direction (A).

According to a further non-limiting aspect, the data processing unit (104) is configured to electronically calculate a difference between the distance travelled by said robot (100) calculated by means of said inertial or kinematic calculation system and the distance travelled by said robot (100) calculated by means of the positioning signal received from said antenna and/or unit for receiving a positioning signal, and/or by means of said external positioning system (800) and/or by said second positioning system.

According to a further non-limiting aspect, the robot (100) is configured to transmit an alarm signal when said difference is in absolute value greater with respect to a predetermined critical difference threshold.

In accordance with a further aspect, a method is further disclosed for controlling the position of a robot (100), preferably a robot lawnmower, comprising:
at least a first distance measurement step (2001), in which, starting from a temporary position and/or orientation (X, Y, φ) of said robot (100) with respect to a predetermined reference (200) within a predetermined working area (500), a first distance (70) between a predefined point (103) of said robot (100) and a predefined point (P1) on a perimeter (600) of said predetermined working area (500) is measured, in which
if said first distance (70) is less than a threshold distance value (2002; 2006; 2009), the method comprises a rotation step (2003) of the robot (100) in which said predefined point (103) of said robot (100), placed at a predefined and non-zero distance (K) with respect to a predefined rotation point (71) of said robot (100), is placed at a second distance (70) with respect to said perimeter (600) of said predetermined working area (500), said rotation step (2003) comprising a rotation from a first rotation angle (φ1) of said robot (100) on an azimuthal plane to a second rotation angle (φ2) of said robot (100) on the azimuthal plane.

According to a further non-limiting aspect, the rotation step (2003) comprises an actuation of a movement motor unit (101) of the robot (100) acting on its wheels and/or rollers and/or tracks (102).

According to a further non-limiting aspect, if the second distance (70) is smaller with respect to the first distance (70) and/or if said second distance (70) is smaller than said threshold distance value (2002; 2006; 2009), the method comprises a rotation of said robot (100) by said second rotation angle (φ2) of said robot (100) on an azimuthal plane to at least one further rotation angle (φ3) of said robot (100) on the azimuthal plane.

According to a further non-limiting aspect, following the rotation of said robot (100) from said second rotation angle ((φ2) to at least said one further rotation angle (φ3), the method comprises a further distance measurement step (2001).

According to a further non-limiting aspect, between the first rotation angle (φ1) and the second rotation angle (φ2) and/or between the second rotation angle (100 2) and the third rotation angle (φ3) there is a rotation of at least less than 15°, or less than 10°, or less than 5°, or a rotation of at least 50°, preferably at least 70°, more preferably at least 90°.

According to a further non-limiting aspect, the rotation from said second rotation angle (φ2) to said third rotation angle (φ3) and the rotation from the first rotation angle (φ1) to said second rotation angle (φ2) take place in a same direction,
or the rotation from said second rotation angle (φ2) to said third rotation angle (φ3) occurs in a direction opposite the rotation direction from the first rotation angle (
01) to said second rotation angle (φ2).

According to a further non-limiting aspect, if the second distance (70) is smaller with respect to the first distance (70) and/or if said second distance (70) is smaller with respect to said threshold distance value (2002; 2006; 2009), the rotation step (2003) determines a progressive rotation of said robot (100) around said rotation point (71) and determines the execution of at least one further, preferably a plurality of, distance measurement step(s) (2001).

According to a further non-limiting aspect, the progressive rotation ends when at least in a further, or one of the further, distance measurement step(s) (2001), it is electronically measured that the second distance (70) is greater with respect to the first distance (70) and/or when said second distance (70) is greater than said threshold distance value (2002; 2006; 2009).

According to a further non-limiting aspect, said progressive rotation is such as to determine a maximum rotation of the robot (100) of 360° on the azimuthal plane, and/or between said first rotation angle (
1) and said second rotation angle (φ2) and/or said further rotation angle (φ3) there is a maximum rotation of 360° on the azimuthal plane.

According to a further non-limiting aspect, when following said rotation step, said second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (2002, 2006, 2009), the method comprises a step of stopping the robot (100).

According to a further non-limiting aspect, the method comprises a transmission of an alarm signal.

According to a further non-limiting aspect, said alarm signal is an electronic alarm signal and the method comprises a step of transmitting said electronic alarm signal from said robot (100) to a predetermined portable electronic device, operatively and optionally uniquely, associated with said robot (100), and/or a step of transmitting said electronic alarm signal from said robot (100) to a charging base (400) of said robot (100).

According to a further non-limiting aspect, said alarm signal is a visual and/or sound signal.

According to a further non-limiting aspect, said threshold distance value (2002; 2006; 2009) is electronically modifiable by said robot (100) and/or as a result of a command imposed by said robot (100).

According to a further non-limiting aspect, when following the rotation, the second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (2002, 2006, 2009), the method comprises:
an electronic modification of said threshold distance value (2002; 2006; 2009), in which said threshold distance value (2002; 2006; 2009) is reduced by a predetermined amount,
following said electronic modification, the automatic execution of at least one further rotation step (2003).

According to a further non-limiting aspect, when following said rotation, said second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (2002, 2006, 2009), the method comprises:
if necessary, a rotation step of said robot (100) around said rotation point (71), to bring said robot (100) back at said first rotation angle (φ1);
a translation step of said robot (100) at a predefined reference position within said predetermined working area (500), the translation step occurring following the rotation step to bring said robot (100) back at said first rotation angle (φ1), if executed.

According to a further non-limiting aspect, the translation step is preferably a linear translation step and/or in which said predefined reference position is a position assumed by said robot (100) prior to said first distance measurement step (2001).

According to a further non-limiting aspect, when following said rotation step, said second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (2002, 2006, 2009), the method comprises:
an electronic identification step of an auxiliary rotation angle (φmax) of the robot (100) on the azimuthal plane at which said predefined point (103) is placed at a maximum distance with respect to the perimeter (600);
subsequently, a movement step (2004; 2007; 2010), which automatically ends when the robot (100) has travelled at least a predefined translation distance along a predetermined linear direction identified by the auxiliary rotation angle (φmax).

According to a further non-limiting aspect, in which when following said rotation step, said second rotation angle (φ2) and/or said further rotation angle (φ3) again coincides with said first rotation angle (φ1), and/or when said progressive rotation has determined, and ends with, a rotation of said robot (100) of 180°, the method comprises a subsequent movement step of said robot (100) comprising a movement, preferably a linear translation, of said robot (100), for a movement distance, preferably a linear translation distance, which is different with respect to a movement distance, preferably a linear translation distance, of said robot (100) prior to said rotation step and/or said progressive rotation.

According to a further non-limiting aspect, the method comprises a step of temporarily storing a plurality of pairs [rotation angle φr; distance D] on an electronic memory (300), in which said rotation angle φr is a rotation angle of the robot (100) on the azimuthal plane, optionally measured with respect to a predefined reference direction, and in which said distance D is a distance assumed by the predefined point (103) of the robot (100) with respect to said perimeter (600), optionally with respect to said predetermined point (601) on said perimeter (600).

According to a further non-limiting aspect, the electronic identification step of said auxiliary rotation angle (φmax) follows said storage.

According to a further non-limiting aspect, said plurality of pairs [rotation angle φr; distance D] defines a data set ([rotation angle φr1; distance D1]-[rotation angle φN; distance DN]) of pairs [rotation angle φr; distance D]).

According to a further non-limiting aspect, the step of electronically identifying said auxiliary rotation angle ((max) comprises electronically scanning the entire dataset to search for a maximum distance value (DMAX) between the distance values (D1. . . DN) contained in said dataset.

According to a further non-limiting aspect, the method comprises an electronic selection of the specific rotation angle (φr) corresponding to the pair whose distance (D) is said maximum distance value (DMAX), and comprises an acquisition of said specific auxiliary rotation angle as an auxiliary rotation angle (φmax).

According to a further non-limiting aspect, the method comprises activating the movement motor unit (101) to cause a rotation of the robot (100) on itself, so as to place it in the orientation corresponding to the auxiliary rotation angle (φmax).

According to a further non-limiting aspect, the method comprises an activation of the movement motor unit (101) to cause the linear translation of said robot (100) for a distance corresponding to said predefined translation distance.

According to a further non-limiting aspect, the predefined reference position is a position previously assumed by said robot (100).

According to a further non-limiting aspect, the translation step of said robot (100) at said predefined reference position is a step taking place at at least one predefined portion of said working area (500) characterized by an elongated and narrow shape with respect to at least one dimension of said robot (100) on said azimuthal plane.

In accordance with a further aspect, a robot (100) is further disclosed, preferably an automatic-driving robot lawnmower, comprising:
a movement motor unit (101);
wheels and/or rollers and/or tracks (102), connected to said movement motor unit (101) and configured to determine a movement of the robot (100);
a data processing unit (104), configured to perform at least a first electronic measurement (2001) of a distance between a temporary position and/or orientation (X, Y, φ) of said robot (100) with respect to a predetermined reference (200) within a predetermined working area (500) and determine a first distance (70) between a predefined point (103) of said robot (100) and a predefined point (P1) on a perimeter (600) of said predetermined working area (500), in which
the robot (100) is configured to rotate on itself at a rotation point (71) placed at a predefined and non-zero distance with respect to said predefined point (103),
said data processing unit (104) is configured to calculate a difference between said first distance (70) and a threshold distance value (2002; 2006; 2009),
and in which, if said distance (70) is less than a threshold distance value (2002; 2006; 2009), the data processing unit (104) is configured to drive said movement motor unit (101) so as to determine, by means of said wheels and/or rollers and/or tracks (102), a rotation (2003) of the robot (100) and to determine, by means of said rotation, a displacement of said predefined point (103) of said robot (100) at a second distance (70) with respect to said perimeter (600) of said predetermined working area (500), the rotation (2003) taking place from a first rotation angle (φ1) of said robot (100) on an azimuthal plane to a second rotation angle (φ2) of said robot (100) on the azimuthal plane.

According to a further non-limiting aspect, said rotation point (71) and said predefined point (103) are aligned along a direction substantially orthogonal to a direction joining said wheels and/or rollers and/or tracks (102), and/or in which said wheels and/or rollers and/or tracks (102) are aligned along an axis comprising said rotation point (71).

According to a further non-limiting aspect, said rotation point (71) being placed at substantially half of a distance passing between said wheels and/or rollers and/or tracks (102).

According to a further non-limiting aspect, said wheels and/or rollers and/or tracks (102) comprise a first and a second wheel respectively positioned on a left side and a right side of said robot (100) and/or comprise a first and a second track respectively positioned on a left side and on a right side of said robot (100).

According to a further non-limiting aspect, if the second distance (70) is smaller with respect to the first distance (70) and/or if said second distance (70) is smaller than said threshold distance value (2002; 2006; 2009), the data processing unit (104) is configured to drive said movement motor unit (101) so as to determine, by means of said wheels and/or rollers and/or tracks (102), a rotation of said robot (100) from said second rotation angle (φ2) of said robot (100) on an azimuthal plane to at least one further rotation angle (φ3) of said robot (100) on the azimuthal plane.

According to a further non-limiting aspect, the data processing unit (104) being configured to cause the execution of a further distance measurement step (2001) following said rotation.

According to a further non-limiting aspect, the rotation from said second rotation angle (φ2) to said third rotation angle (φ3) and the rotation from the first rotation angle (φ1) to said second rotation angle (φ2) take place in a same direction or in which the rotation from said second rotation angle (φ2) to said third rotation angle (φ3) takes place in an opposite direction with respect to the rotation direction from the first rotation angle (φ1) to said second rotation angle (φ2).

According to a further non-limiting aspect, if the second distance (70) is smaller with respect to the first distance (70) and/or if said second distance (70) is smaller with respect to said threshold distance value (2002; 2006; 2009), the data processing unit (104) is configured to drive said movement motor unit (101) so as to determine, by means of said wheels and/or rollers and/or tracks (102) a progressive rotation of said robot (100) around said rotation point (71) and to perform at least one further, preferably a plurality of, distance measurement(s) (2001), and to stop said movement motor unit (101), thereby determining a stop of said progressive rotation when at least one further, or one of the further, distance measurement(s) (2001), it is electronically measured that the second distance (70) is greater with respect to the first distance (70) and/or when said second distance (70) is greater with respect to said threshold distance value (2002; 2006; 2009).

According to a further non-limiting aspect, said progressive rotation is such as to determine a maximum rotation of said robot (100) of 360° on the azimuthal plane, and/or in which between said first rotation angle (φ1) and said second rotation angle (φ2) and/or said further rotation angle (φ3) there is a maximum rotation of 360° on the azimuthal plane.

According to a further non-limiting aspect, when following said rotation step, said second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (202, 2006, 2009), the data processing unit (104) is configured to automatically stop the operation of said movement motor unit (101) so as to determine the stop of the robot (100).

According to a further non-limiting aspect, the data processing unit 104 is configured to transmit an alarm signal.

According to a further non-limiting aspect, said alarm signal is an electronic alarm signal and the data processing unit (104) is configured to transmit said electronic alarm signal from said robot (100) to a predetermined portable electronic device, operatively and optionally uniquely, associated with said robot (100), and/or is configured to transmit said electronic alarm signal from said robot (100) to a charging base (400) of said robot (100).

According to a further non-limiting aspect, said alarm signal is a visual and/or sound signal.

According to a further non-limiting aspect, said threshold distance value (2002; 2006; 2009) is electronically modifiable by said robot (100) and/or as a result of a command imposed by said robot (100).

According to a further non-limiting aspect, when following said rotation, the second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (2002, 2006, 2009), the data processing unit (104) is configured to:
electronically modify said threshold distance value (2002; 2006; 2009), reducing it by a predetermined amount,
following said modification, automatically determine the start of a further rotation (2003) of said robot (100).

According to a further non-limiting aspect, when following said rotation, said second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (202, 2006, 2009), the data processing unit (140) is configured to:
if necessary, actuate the movement motor unit (101) of said robot (100) to determine, by means of said wheels and/or rollers and/or tracks (102), a rotation of the robot (100) around said rotation point (71), to bring said robot (100) back at said first rotation angle ((φ1);
actuate the movement motor unit (101) to translate said robot (100) at a predefined reference position within said predetermined working area (500), the actuation of the movement motor unit (101) to translate said robot (100) occurring following the rotation to bring said robot (100) back at said first rotation angle (φ1), if executed.

According to a further non-limiting aspect, the translation is preferably a linear translation and/or in which said predefined reference position is a position assumed by said robot (100) prior to said first distance measurement step (2001).

According to a further non-limiting aspect, when following said rotation, said second rotation angle (φ2) and/or said further rotation angle (φ3) again coincides with said first rotation angle (φ1), and/or when said progressive rotation has determined a rotation of said robot (100) of 360° on the azimuthal plane without said second distance (70) ever reaching a value equal to or greater than said threshold distance value (2002, 2006, 2009), the data processing unit (140) is configured to:
electronically identify an auxiliary rotation angle (φmax) of the robot (100) on the azimuthal plane at which said predefined point (103) is placed at a maximum distance with respect to the perimeter (600);
subsequently, activate a movement (2004; 2007; 2010), which automatically ends when the robot (100) has travelled at least a predefined translation distance along a predetermined linear direction identified by the auxiliary rotation angle (φmax).

According to a further non-limiting aspect, when following said rotation, said second rotation angle (φ2) and/or said further rotation angle (φ3) again coincides with said first rotation angle (φ1), and/or when said progressive rotation has determined, and ends with, a rotation of said robot (100) of 180°, the data processing unit (140) is configured to activate in motion said robot (100), preferably through a linear translation, for a movement distance, preferably a linear translation distance, which is different with respect to a movement distance, preferably a linear translation distance, travelled by said robot (100) in a movement activation prior to said rotation and/or said progressive rotation.

According to a further non-limiting aspect, the data processing unit is configured to determine a temporary storage of a plurality of pairs [rotation angle φr; distance D] on an electronic memory (300), in which said rotation angle φr is a rotation angle of the robot (100) on the azimuthal plane, optionally measured with respect to a predefined reference direction, and in which said distance D is a distance assumed by the predefined point (103) of the robot (100) with respect to said perimeter (600), optionally with respect to said predetermined point (601) on said perimeter (600).

According to a further non-limiting aspect, the electronic identification of said auxiliary rotation angle (φmax) follows said storage.

According to a further non-limiting aspect, said plurality of pairs [rotation angle or; distance D] defines a data set ([rotation angle φr1; distance D1]-[rotation angle φN; distance DN]) of pairs [rotation angle φr; distance D]).

According to a further non-limiting aspect, the data processing unit, in the electronic identification of said auxiliary rotation angle (φmax), is configured to electronically scan the entire dataset in said electronic memory (300) to search for a maximum distance value (DMAX) between the distance values (D1 . . . DN) contained in said dataset.

According to a further non-limiting aspect, the data processing unit is configured to electronically select the specific rotation angle (φr) corresponding to the pair whose distance (D) is said maximum distance value (DMAX), and is configured to acquire said specific auxiliary rotation angle as auxiliary rotation angle (φmax).

According to a further non-limiting aspect, the data processing unit is configured to activate the movement motor unit (101) to cause a rotation of the robot (100) on itself, so as to place it in the orientation corresponding to the auxiliary rotation angle (φmax).

According to a further non-limiting aspect, the data processing unit is configured to activate the movement motor unit (101) to cause the linear translation of said robot (100) for a distance corresponding to said predefined translation distance.

According to a further non-limiting aspect, the predefined reference position is a position previously assumed by said robot (100).

According to a further non-limiting aspect, the translation of said robot (100) at said predefined reference position occurs at at least one predefined portion of said working area (500) characterized by an elongated and narrow shape with respect to at least one dimension of said robot (100) on said azimuthal plane.

### PRESENTATION OF THE DRAWINGS

The following detailed disclosure provides a disclosure of some preferred and non-limiting embodiments of the subject matter of the disclosure, with the help of the accompanying figures, a brief description of which is provided below. It is intended to specify that, for the purposes of the invention referred to in the present disclosure and in the appended claims, the terms “orientation” and “orienteering” are to be considered as synonymous.

FIG. 1 shows a plan view of a self-driving robot, in particular a robot lawnmower, within a predefined working area in which there is also a charging station for said robot.

FIG. 1a shows a first solution in which a predefined positional reference for said robot is defined by a charging base.

FIG. 1b shows a second solution, alternative to the first, in which a predefined positional reference for said robot is defined on a position and/or orientation of a ground station which is located remotely with respect to said charging base.

FIG. 2 shows a simplified flowchart of a procedure for imposing or resetting the position and/or orientation assumed by said robot.

FIG. 3 shows a simplified block diagram showing a procedure for measuring a difference between an actual position and/or orientation and an estimated position and/or orientation of said robot and a comparison of said difference with respect to a threshold value.

FIG. 4 shows a simplified flowchart for the acquisition of the perimeter of the working area of the robot.

FIG. 5 shows a plan view of a specific embodiment of a robot lawnmower positioned at a first distance with respect to a perimeter of the working area.

FIG. 6 shows a flowchart of a process for rotating and moving the robot to acquire the position and/or orientation thereof in said working area.

FIG. 7 shows a plan view of a specific embodiment of a robot lawnmower in which a rotation thereof with respect to a rotation point is highlighted to allow the distancing of a predefined portion of the robot with respect to the perimeter of the working area.

FIG. 8 shows a plan view of a specific embodiment of a robot lawnmower, in a rotated position and/or orientation with respect to the direction originally assumed.

### DETAILED DESCRIPTION

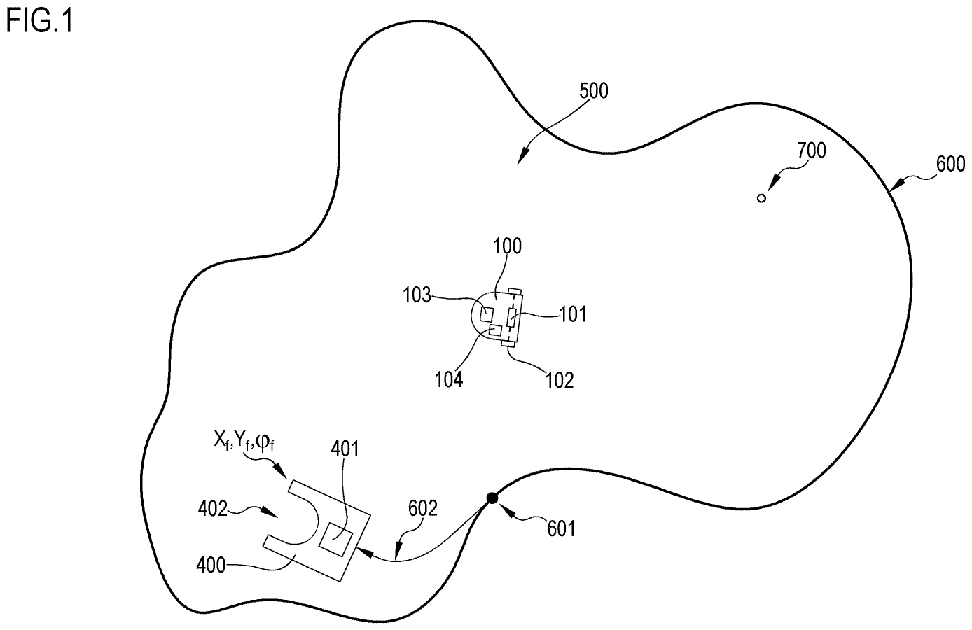

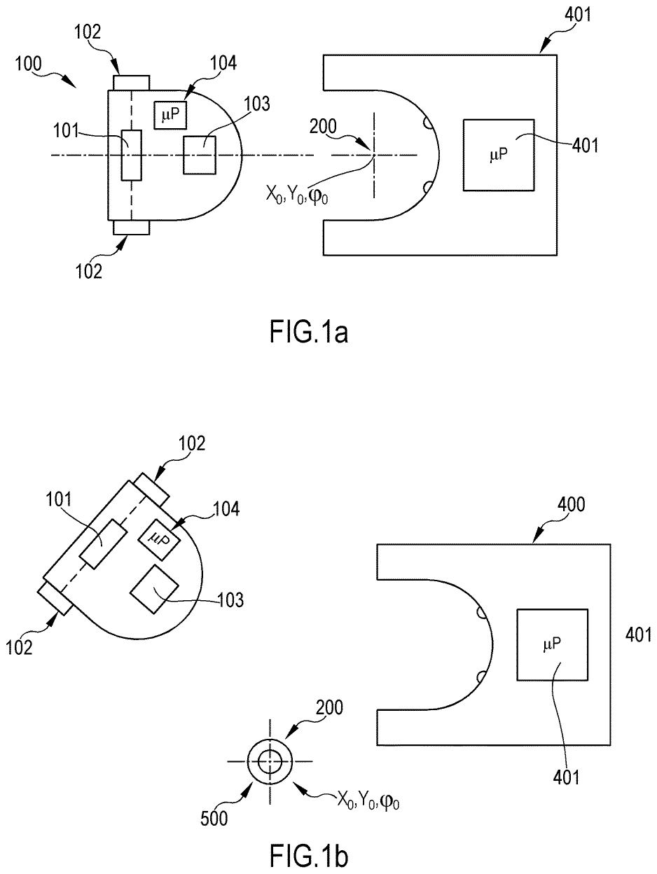

FIG. 1 shows a working area 500 of a robot 100, preferably but not limited to a robot lawnmower. The working area 500 may, by way of non-limiting example, be a non-interbated ground, a lawn, a floor inside or outside a building. The working area is delimited by a perimeter 600. In the embodiment disclosed in FIG. 1, the perimeter 600 is identified by a closed curve, free of angular points. However, the perimeter 600 of the working area 500 may be identified by a closed curve which comprises one or more angular points.

In the course of the present disclosure, reference will be made to a predetermined working area 500, meaning that such a working area is not defined randomly or arbitrarily or is without limits; otherwise, the working area 500 is defined on the basis of a perimeter 600.

In an embodiment, such a perimeter 600 lacks reference wire. This means that in such an embodiment, the robot 100 which is disclosed herein is a wirelessly guided robot.

The robot 100 is a self-driving robot; this means that the robot 100 comprises at least one working operating configuration of a tool thereof, during which it moves within the working area 500 following a movement which, basically, is automated and does not require the intervention of an operator. In a specific embodiment in the working operating configuration, the robot 100 executes a mowing of the lawn by means of a mowing plate or bar. The mowing of the lawn within the working area 500 can be executed based on a predefined mowing algorithm which advantageously allows to reduce as much as possible the overall path travelled by the robot 100 to complete the mowing of the lawn on the entire working area 500 without neglecting any portion thereof.

In an embodiment the cutting algorithm, or more generally the algorithm for using the tool in the working operating configuration of the robot 100 is fixed, and is not adapted as a function of the specific condition in which the robot 100 is to operate.

In an alternative embodiment, the cutting algorithm, or more generally the algorithm for using the tool in the working operating configuration of the robot 100 can be varied in accordance with the specific shape of the working area 500. The variation of the use algorithm of the tool is preferably automated. This means that the data processing unit 104 of the robot 100, which oversees the management of the working operating configuration, automatically manages the adaptation of the use algorithm of the tool.

The working operating configuration can be activated manually by the user or can take place automatically based on established times, and/or based on days of the week and/or based on external data including—for example—temperature and/or humidity conditions.

In a specific embodiment, the working operating configuration can only be started when the robot 100, by means of the data processing unit 104, identifies a sufficient charge for the battery. Otherwise, the data processing unit 104 prevents the activation of the working operating configuration.

The working operating configuration ends when the entire working area 500 has been worked or, alternatively, when the battery charge level falls below a minimum safety charge value. Such a value may for example be defined as that value which allows the charging base 400 to be reached from the most remote position of the working area 500.

A robot 100 is first identified within the working area 500, preferably a robot lawnmower, which is provided with a movement motor unit 101 thereof, and with wheels and/or rollers and/or tracks operatively (in particular, mechanically) connected to the movement motor unit 101 so as to allow the movement of the robot along a path which can be straight and/or curved. In a non-limiting embodiment, the movement motor unit 101 comprises at least one electric motor, preferably brushless, and more in particular comprises at least a first electric movement motor and a second electric movement motor. The first electric movement motor is preferably connected to the wheels and/or rollers and/or tracks 102 arranged on the left side (first side) of the robot 100; the second electric movement motor is preferably connected to the wheels and/or rollers and/or tracks 102 arranged on the right side (second side) of the robot 100. The first electric movement motor and the second electric movement motor are independently controllable.

The robot 100 object of the present disclosure is preferably configured to execute a rotation on itself. Such a rotation preferably occurs at a predefined rotation point 71 inside the robot body. In a non-limiting embodiment, the robot 100 object of the present disclosure is such that the predefined rotation point 71 is in a position halfway between the wheel and/or the left track and the wheel and/or the right track.

In an embodiment the wheels and/or rollers and/or tracks 102 are positioned in a rear position of the robot 100. Thanks to this feature, when the wheels and/or rollers and/or tracks 102 are driven by the first electric movement motor and the second electric movement motor to move in counter-rotation, the front portion of the robot rotates around the rotation point 71, ideally drawing a circumference when the rotation speed of the wheels and/or rollers and/or tracks 102 on the left is equal to, but opposite, the rotation speed of the wheels and/or rollers and/or tracks 102 on the right.

In light of the above, it is clear that where in the present disclosure reference is made to the activation of the movement motor unit 101, such activation may comprise a selective activation of the first electric movement motor only, a selective activation of the second electric movement motor, a simultaneous activation of the first and second electric movement motors. The activations disclosed above may occur in a rotation direction in agreement or disagreement, and/or at the same rotation speed or at different rotation speeds.

The robot 100 integrates within its body a battery, which can be recharged and which can also be removable from the robot body. The battery is electrically connected to the movement motor unit 101. The battery provides electricity to the auxiliary electronic components necessary for the operation of the robot; such components are in particular a data processing unit 104 and/or a receiver of navigation signals coming from an external positioning system 800.

As will be better clarified later in the present disclosure, in a non-limiting embodiment the external positioning system 800 can be a second positioning system for the robot 100, which acts in concert with an internal positioning system of the robot (first positioning system) for example of inertial type to define the position and/or orientation of the robot 100 or be a further positioning system with respect to the external positioning system 800.

In a non-limiting embodiment, the battery is a lithium battery. The robot 100 is therefore configured to receive positioning data from said external positioning system 800 (and/or from the second positioning system) and is in particular configured to receive such positioning data on a wireless radio channel. In FIG. 1, the reference numeral 103 identifies a predefined point within the surface of the robot 100; this point, as will be better clarified in the following portion of the disclosure, is taken as a reference point for an electronic calculation of a distance assumed by the robot 100 with respect to the perimeter 600 of the working area 500.

In a non-limiting embodiment, the navigation signal receiver is positioned at the predefined point 103, and in particular the antenna is positioned there.

In light of the above, it is therefore clear that the rotation point 71 and the predefined point 103 are aligned along a direction substantially orthogonal to a direction joining the wheels and/or rollers and/or tracks 102, and the wheels and/or rollers and/or tracks 102 are aligned along an axis which comprises the rotation point 71. The distance K which separates the rotation point 71 and the predefined point 103, is maximized as much as possible in the design phase. In a non-limiting embodiment, the predefined point 103 lies substantially at a front end portion of the robot 100 and/or at a position of the body of the robot 100 which is substantially opposite (when the robot 100 is viewed in plan, i.e., from above) with respect to the position in which the rotation point 71 lies.

The maximization of the distance between the rotation point 71 and the predefined point 103 allows to reduce the impact of the positioning precision of the robot 100 and/or of the possible slippage of one or more of the wheels and/or rollers and/or tracks 102 during the rotation of the robot, in the precision of identifying the rotation angle of the robot itself and/or in the precision of measuring the distance from a predefined point of the perimeter 600 of the working area 500 and/or in the precision of measuring a distance difference with respect to a predefined point of the perimeter 600 of the working area 500.

Depending on the specific function, the robot 100 of the present disclosure may comprise a work tool such as a mowing blade or a rotating brush, in accordance with the specific technical working function to be executed during the normal operating condition. If the robot 100 is a robot lawnmower, conveniently there may be a container adapted to contain part of the grass cut by the robot itself therein.

The robot 100 further comprises at least one drive motor, operatively connected with the work tool; preferably, the drive motor is an electric motor. The battery also powers the drive motor. The data processing unit 104 present on board the robot 100 allows the activation of the drive motor.

In FIG. 1, a charging station 400 for the robot 100 is also shown. The charging station 400 is located in a predefined position within the working area 500 or at the perimeter 600 of the working area 500.

The charging station 400 comprises a control unit 401 which is configured to manage the delivery of electricity to the battery of the robot 100 and a coupling portion 402, at which a predefined portion of the robot 100, in particular the front portion of the robot 100, is at least partially introduced in use. The charging of the battery of the robot 100 may occur for example by means of the contact between electrical contacts of the robot 100 and electrical contacts of the charging station 400, in particular positioned substantially at the coupling portion 402 or, alternatively, by means of an inductive coupling. In the latter case, magnetic contacts will be present on the robot 100 and on the charging station 400.

The charging station 400, precisely because of the presence of the coupling portion 402, assumes not only a position thereof in the plane but also an orientation thereof with respect to a predefined direction. In FIG. 1, the coordinates Xf and Yf represent the position on the plane of the working area 500; the coordinate of identifies an orientation of the charging station 400 on the azimuthal plane.

It should be noted that for the purposes of the present disclosure, the working area 500 is considered to be planar for the sake of simplicity, although in reality such an area may be non-planar and comprise valleys or raised portions. The azimuthal plane is the ideal plane of the working area or, if FIG. 1 is observed, it is the plane of the sheet on which the figure itself lies.

The robot 100 object of the present disclosure is controlled according to a particular method which is disclosed below.

The method disclosed herein allows to compensate the negative effects in the precision of the positioning and/or orientation of the robot 100 which, in traditional use, are inevitably compromised by at least one of the following factors:
diameter of the wheels and/or rollers and/or tracks, and/or their relative distance transversely (track);
continuous slippage;
discontinuous slippage;
lateral slippage.

The diameter of the wheels and/or rollers and/or tracks is never the one ideally considered, if only because of the wear thereof or because of the sinking in the ground or again because of the curvature thereof. The same holds true for the track.

As far as continuous slippage is concerned, it should be noted that for each rotation of the wheel and/or the roller and/or the track, the robot moves a little more or a little less with respect to the nominal circumference or perimeter. In this sense, the continuous slippage error can also take into account the measurement error of the encoder itself, which is associated with the wheels and/or rollers and/or tracks.

With regard to discontinuous slippage, it should be noted that, for example, at the start of the rotation of the wheels and/or rollers and/or tracks, there may be a temporary rotation thereof without the robot 100 actually moving.

As regards lateral slippage, it is noted that on sloping ground the robot 100 could slip laterally, in particular where the advancement direction is perpendicular to the direction of maximum slope. The lateral slippage of the robot 100 may occur with rotation thereof or with simple translation without rotation.

In particular, in an embodiment, the robot 100 is controlled by a position and/or orientation control method comprising firstly (step 1000) a storing step, in which a first position and/or orientation datum D(X0, Y0, φ0) of the robot 100 positioned in a predetermined point X0, Y0, φ0 of the working area 500 is electronically stored in an electronic memory 300.

The electronic memory 300 may be a memory physically positioned on the robot 100; alternatively, the electronic memory 300 may be a memory of an external server, operatively accessible by the data processing unit 104 of the robot 100. Still alternatively, the memory 300 may be a memory positioned at the charging station 400. Also in the latter case, the memory is conveniently operatively accessible by the data processing unit 104 of the robot 100.

In an embodiment, the predetermined point of the working area 500 identified by the triad of coordinates X0, Y0, φ0 is the point where a predetermined positional reference 200 for the robot 100 is located.

As schematically shown in FIG. 1a, in a non-limiting embodiment, the predetermined point identified by the triad of coordinates X0, Y0, φ0 is a point where the charging station 400 is present. This means that in a non-limiting embodiment, the predetermined positional reference 200 corresponds to said charging station 400; it is therefore clear that the charging station 400 has a known position and/or orientation.

Alternatively, as schematically shown in FIG. 1b, in an alternative embodiment to the previous one, the predetermined point identified by the triad of coordinates X0, Y0, φ0 is a point placed at a predefined distance with respect to the charging station 400.

Of the triad of coordinates of the point X0, Y0, φ0, the coordinates X0 and Y0 represent the position on the plane of the working area 500; the coordinate φ0 identifies an orientation of the robot 100 on the azimuthal plane.

The first position and/or orientation datum D(X0, Y0, φ0) comprises the pair of position coordinates on the plane of the working area 500 and also comprises the coordinate φ0 which identifies the orientation of the robot 100 on the azimuthal plane.

In use, during its movement within the working area 500, the robot 100 assumes a variable position and/or orientation, and therefore temporary, identified by the triad of coordinates X, Y, φ. The X and Y coordinates represent the position of the robot 100 on the plane of the working area 500; the φ coordinate identifies an orientation of the robot 100 on the azimuthal plane. Such coordinates are therefore time-variant.

In turn, a temporary position and/or orientation datum D(X, Y, φ) of the robot 100 comprises the aforementioned triad of coordinates X, Y, φ. The temporary position and/or orientation datum D(X, Y, φ) of the robot 100 is gradually updated in use by the data processing unit 104; the updating frequency of the temporary position and/or orientation datum D(X, Y, φ) can be fixed or variable.

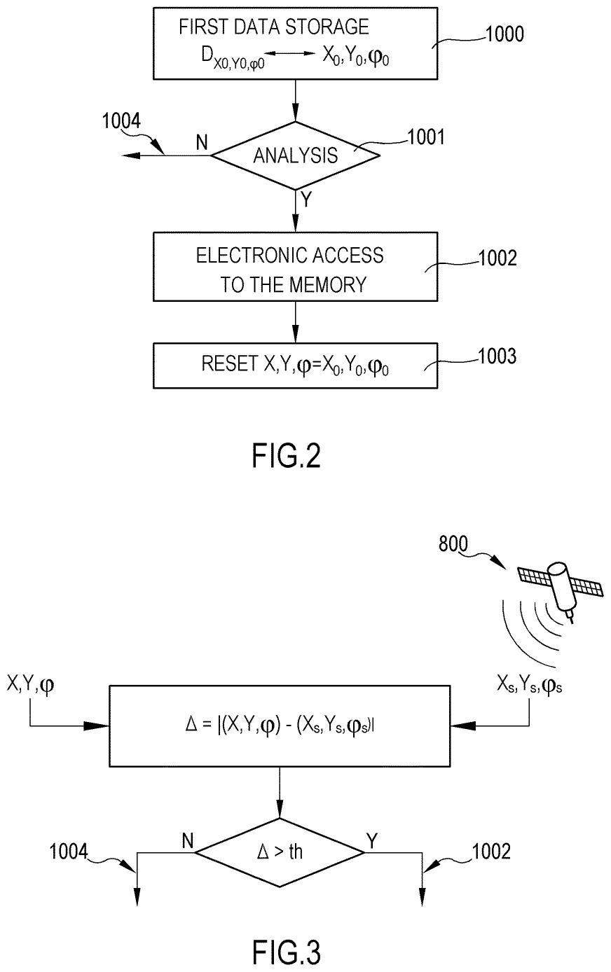

With reference to FIG. 2, the method disclosed herein comprises an analysis step (step 1001) which in turn comprises an electronic analysis of a need to impose or reset the datum D(X, Y, φ) of temporary position and/or orientation X, Y, φ of the robot 100 with respect to the predetermined positional reference 200, imposing or forcing the storage of a new position and/or orientation datum keeping the robot in a fixed position.

The analysis step may occur by exploiting the computational capacity of the data processing unit 104 of the robot 100 or by exploiting, alternatively or in combination, the computational capacity of an external device with respect to the robot.

In principle the analysis step (step 1001) may occur during any moment; however, the analysis step can in particular occur during the working operating configuration. Advantageously, therefore, the method disclosed herein and—correspondingly—the system and the corresponding robot, can carry out the control during the normal operation of the robot, and therefore interrupt—if necessary—the normal operation of the robot to determine a rapid correction which allows to resume, subsequently, the working operating configuration with a correct position. Preferably, although not limitedly, the resumption of the working operating configuration takes place in a substantially automated manner.

The method according to the present disclosure further comprises an access step (step 1002), which comprises electronic access to the memory 300 and which further comprises an extraction from said memory 300 of the first position and/or orientation datum D(X0, Y0, φ0). The memory extraction step follows the electronic access step and is clearly an electronic extraction step. Where the memory 300 is of the robot 100, it is clear that the electronic access is executed by the data processing unit 104 to the memory of the robot itself, alternatively such access will be directed to a device (charging station 400, remote server) which is external with respect to the robot 100.

Downstream of the access step, the method object of the present disclosure includes a position and/or orientation imposition or reset step (step 1003), in which, if necessary, the robot 100 is driven in motion, by means of the movement motor unit 101 thereof, so as to be positioned at the predetermined positional reference 200.

Clearly, the driving in motion of the robot 100 is executed only if the robot 100 is not at the predetermined positional reference 200; if so, it is not necessary to proceed with the driving in motion of the robot 100 to determine the displacement thereof in the aforesaid predetermined positional reference 200.

The fact that the robot 100 is not at the predetermined positional reference means that the position and/or orientation X, Y, φ temporarily assumed by the robot 100 does not correspond to that of the predetermined positional reference 200.

However, in the position and/or orientation imposition or reset step, keeping the robot 100 at the positional reference 200, the datum D(X, Y, φ) of temporary position and/or orientation X, Y, φ of the robot 100 is electronically forced to said first position and/or orientation datum D(X0, Y0, φ0).

It is therefore clear that the position and/or orientation imposition or reset step 1003 determines a storage of the first position and/or orientation datum D(X0, Y0, φ0) as temporary position and/or orientation datum D(X, Y, φ) of the robot 100.

Where the predetermined positional reference 200 is that of the charging station 400, the driving in motion of the robot 100 for reaching the predetermined positional reference 200 comprises the robot 100 reaching the charging station 400.

The Applicant has conceived a certain step for verifying and/or identifying having reached the charging station 400; such reaching is in particular determined and/or electronically identified by a coupling between the electrical and/or magnetic contacts of the charging station 400 with electrical and/or magnetic contacts of the robot 100.

Where the predetermined positional reference 200 instead does not coincide with the position assumed by the charging station 400, the robot 100 reaching the predetermined positional reference 200 is determined by an alteration of an operating state of the robot 100 by means of a physical interaction step between the predetermined positional reference 200 and the robot 100.

A particular embodiment of the system disclosed herein comprises a positional reference 200 which, in addition to having a predefined position and/or orientation identified by the coordinates X0, Y0, φ0, is also placed at a predefined distance and/or orientation with respect to the charging station 400. In so doing, it is possible to derive the position and/or orientation assumed by the charging station 400 by means of a simple calculation.

Preferably, but not limitedly, the predetermined positional reference 200 is a predetermined physical positional reference. In particular, in an embodiment which is not to be understood as limiting, the positional reference 200 lies at, or is, a positioning precision augmenting station for the robot 100; in particular, such a precision augmenting station cooperates with the external positioning system 800 disclosed herein. In a specific, but non-limiting embodiment, the predetermined positional reference 200 lies at, or is, a pseudolite, i.e., a pseudo-satellite comprising a transmitting station which radiates a positioning signal similar to that of a global satellite positioning system in order to reduce the impact of the dilution of precision (DOP) in particular where the working area of the robot 100 is adjacent to very tall and/or dense forests, cliffs, buildings.

It is therefore clear that the method according to the present disclosure may also comprise a step of altering the operating state of the robot 100 when it reaches at the charging station 400 and/or the predetermined positional reference 200.

It should be noted that the predetermined positional reference 200 may be arranged at a height substantially coincident with the height at which the robot 100 operates or can be positioned at a greater height with respect to the height at which the robot 100 operates.

The method disclosed in accordance with the present disclosure further comprises a movement step (step 1004), in which the robot 100 is moved, by means of the activation of the movement motor unit 101, within the working area 500. The movement of the robot 100 determines an alteration of the datum D(X, Y, φ) of temporary position and/or orientation X, Y, φ of the robot 100.

The alteration of the aforesaid datum D(X, Y, φ) occurs at a rate substantially controlled by the data processing unit 104 and, preferably predefined or variable.

It should be noted in particular that the alteration takes place in accordance with positioning data transmitted to said robot 100 by an external positioning system 800 and/or by the second positioning system, and/or by positioning data determined by the movement motor unit 101 and/or by wheels and/or rollers and/or tracks 102 of said robot 100 and/or by a camera of said robot 100 and/or in relation to a delimiting wire of said predetermined working area 500.

Where the alteration of the datum D(X, Y, φ) of temporary position and/or orientation X, Y, φ of the robot 100 takes place in relation to an external positioning system 800 or a second positioning system, this means that the robot 100 receives by means of the aforementioned receiver a positioning datum from an external positioning system 800 and/or a second positioning system.

In a preferred embodiment, the at least one external positioning system 800 is a global positioning system, preferably of the satellite type.

Examples of such types of positioning systems can be GPS, Galileo, Beidou, Glonass, IRNSS, QZSS and through by means of such data, based on an electronically calculated difference, determines the need or not to perform the aforementioned reset.

Preferably, without limitation, there may be a differential correction of the position datum temporarily assumed by the robot 100; the differential correction occurs with the transmission of a position correction datum from a ground station 700 having a known position and/or orientation towards the robot 100. In a non-limiting embodiment, the ground station 700 is located within the working area 500; in a specific but non-limiting embodiment, the ground station 700 is located on the charging base 400, or near the charging base 400, or within the working area 500 of the robot 100, but on a support such as to place said ground station 700 at a greater height, in particular significantly higher (1 m or 2 m, for example) with respect to the height at which the robot 100 normally operates. It is however important that the ground station 700 is located in a fixed position. In a non-limiting embodiment, the ground station 700 coincides with the predetermined positional reference 200.

In an embodiment, therefore, the system disclosed herein is configured to operate in a performance augmenting configuration provided by the global satellite navigation system. Such an augmented configuration is intended to allow to increase performance, such as integrity, accuracy, continuity, or availability of positioning data of the robot 100 through the use of information external to the global navigation satellite system (GNSS).

Several augmentation solutions may be understood as available to achieve the technical effect disclosed above; among these solutions, a specific solution is the use of an RTK algorithm.

RTK, Real Time, Kinematic, is a technique used to improve the precision of position data deriving from global satellite positioning systems, which allows to achieve a precision in the order of a centimetre on the horizontal plane (plane of the working area 500 or azimuthal plane) and two centimetres on the vertical plane (plane orthogonal to the azimuthal plane, or zenithal plane). With the RTK technique, a fixed base station is employed, for example and not limitedly positioned substantially at the charging base 400 or the predetermined position 200 in the working area 500, and a further receiver positioned on the robot 100 to reduce the position error of the robot itself. The fixed base station is configured to transmit a position correction signal to the robot 100.

In an RTK measurement system, two subsequent RTK position estimates are executed as a result of applying an RTK algorithm. In the RTK measurement system, the speed of the robot 100 is electronically calculated by subtracting successive position measurements on the azimuthal plane (X-Y plane) of the working area 500 and dividing the result obtained by a time electronically derived from the difference between the time stamp of the second (successive) position measurement and the first (previous) position measurement. The orientation angle o of the robot 100 is calculated as the angle of a hypothetical line, which joins the two points of the measurements.

The Applicant has observed that when the robot moves slowly, the measurement of position and/or orientation of the robot 100 may be considered noisier with respect to the measurement obtained by a robot moving with a greater speed.

Alternatively and/or in combination with the above, where the alteration of the datum D(X, Y, φ) of temporary position or orientation X, Y, φ of the robot 100 takes place in relation to a determination made by means of a movement motor unit 101 and/or wheels and/or rollers and/or tracks 102 of said robot 100, this means that an inertial or kinematic system of the robot 100 is present, which takes into account the revolutions of the movement motor unit 101 and/or the wheels and/or rollers and/or tracks 102 to determine the need to reset the position and/or vary the position and/or orientation and/or orientation variation of the robot 100.

In light of the above, it is therefore clear that the robot 100 disclosed herein is a robot configured to autonomously identify the position and/or orientation thereof by means of two independent positioning systems, which in a preferred embodiment are the inertial system mentioned herein and the external positioning system 800. While the first positioning system is typically the inertial system mentioned herein, the second positioning system may be a positioning system, also satellite, which is distinct with respect to the external positioning system 800.

The robot 100 disclosed herein may thus be considered a robot with position correction and/or compensation by means of an external positioning system 800.

In the method disclosed herein, therefore, the movement of the robot 100 within the working area 500 occurs by means of a position and/or orientation control by means of two independent positioning systems. This is especially valid above all during the operating working configuration, but also during the further conditions in which the robot is operating, in particular during the “3-step” procedure.

For the purposes of the present disclosure, “inertial system” means a system for identifying the position and/or orientation of the robot 100 which is based on a gyroscope or gimbal and/or on angular velocity sensors for example of the quartz type; the inertial system is configured to identify, directly and/or indirectly, the triad of coordinates X, Y, φ which identifies the position assumed by the robot 100 in the working area 500. The inertial system is preferably part of an IMU (Inertial Measurement Unit) installed on board the robot 100.

“Kinematic system” instead means a system which, as previously mentioned, is directly interfaced to the movement motor unit 101 and/or to the wheels and/or rollers and/or tracks 102 of the robot 100 to allow the aforesaid triad of coordinates X, Y, φ to be identified.

In a specific and non-limiting embodiment, the robot 100 integrates a position and/or orientation predictor, which is configured to predict a future position and/or a future orientation based on the current position and/or orientation (determined by the triad of coordinates X, Y, φ) and/or positions and/or orientations assumed by the robot in the past. The position predictor may also be used as a system for correcting the position and/or orientation data of the robot 100 obtained by means of the inertial or kinematic system of the robot 100.

In a non-limiting embodiment, the predictor comprises a Kalman filter. Such a predictor may be physically made as a separate device with respect to the data processing unit 104, or may be a software module implemented in the programming of the data processing unit 104.

In a non-limiting embodiment, the predictor may be selectively activated or deactivated for example to make, and respectively not make, a correction to the triad of coordinates X, Y, φ which identify the position currently assumed by the robot 100 and which are determined by the inertial or kinematic system.

In particular, the data processing unit 104 of the robot 100 may be configured to activate and/or use the predictor during the working operating configuration of the robot 100. At the methodological level, this means activating the predictor during the use of the robot 100.

However, it should be noted that the robot 100 disclosed herein typically operates in conditions of strong non-linearity. In particular, it should be noted that the influence of angles, understood both as angles of non-planarity of the working area 500, and as angles of orientation of the robot on the azimuthal plane with respect to a reference direction, make the robot 100 the equivalent of a significantly non-linear system. For this reason, the predictor preferably implemented on the robot 100 is a UKF (Unscented Kalman Filter).

Still alternatively and/or in combination with the above, where the alteration of the datum D(X, Y, φ) of temporary position and/or orientation X, Y, φ of the robot 100 takes place in relation to a determination performed by means of a camera of said robot 100, this means that a camera is present on the body of the robot 100 which is capable of capturing a portion of the working area 500 and, by means of appropriate image processing algorithms not disclosed herein, the data processing unit 104 of the robot is capable of determining an advancement and/or a rotation of the robot so as to assess the need to perform the reset disclosed above.

Still alternatively and/or in combination with the above, where the alteration of the datum D(X, Y, φ) of temporary position and/or orientation X, Y, φ of the robot 100 takes place in relation to a delimiting wire of the predetermined working area 500, this means that sensors will be present on the robot 100 which allow to identify an approach and/or a distancing and/or a rotation alteration of the robot 100 with respect to a predetermined portion of the perimeter 600 of the working area 500 to allow to evaluate the need to perform the previously disclosed reset.

The aforementioned analysis step (step 1001) comprises electronically calculating a difference between the position datum and the datum D(X, Y, φ) of temporary position and/or orientation X, Y, φ of the robot 100 and a positioning datum of the robot 100 measured by means of the external positioning system 800 and/or by means of the second positioning system. Where such a difference (also called deviation) is greater with respect to a predetermined threshold value, the position and/or orientation imposition or reset step takes place; if not, no.

The aforementioned calculation of the difference (deviation) comprises for example the calculation of an absolute difference value between the datum D(X, Y, φ) of temporary position and/or orientation X, Y, φ of the robot 100 and a positioning datum of the robot 100 measured by means of the external positioning system 800 and/or by means of the second positioning system, and/or by means of the inertial or kinematic system and/or by means of the wire and/or by means of the camera.

In accordance with the specific model and/or the specific function carried out by the robot 100 object of the present disclosure, the difference may for example be less than or equal to 100 cm. Alternatively, such a difference may be equal to or less than 50 cm, or equal to or less than 25 cm or equal to or less than 15 cm.

In an embodiment, if the deviation is greater with respect to the predetermined threshold value, the method comprises a movement step (step 1004), in which the robot 100 is moved, by means of the action of the movement motor unit 101, within said predetermined working area 500 towards the charging station 400. Such a movement step may advantageously allow at least a partial recharging of the batteries of the robot 100. It is therefore clear that the data processing unit, in particular the data processing unit 104 of the robot 100, is configured to determine a movement of the robot 100 within the working area 500 towards said charging station 400.

The following portion of the disclosure, the mode in which the perimeter 600 of the working area 500 is determined is disclosed.

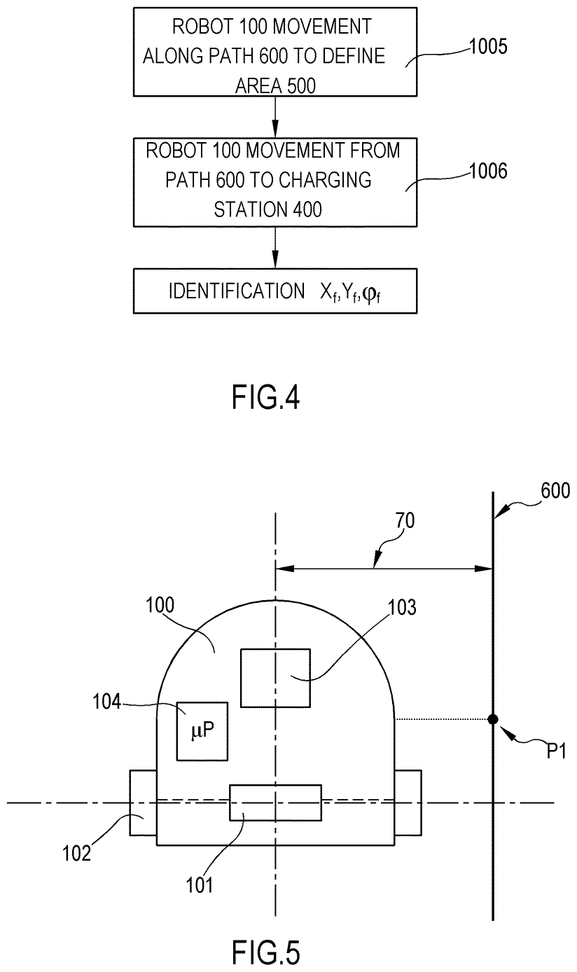

With reference to the simplified block diagram of FIG. 4, the method object of the present disclosure comprises a step of determining a perimeter (step 1005), intended to define the predetermined working area 500. The step 1005 comprises a movement of the robot 100 along a path arbitrarily defined by the user, which will subsequently become the perimeter 600.

The path 600 is defined starting from an initial point 601 in which the robot 100 assumes a known position and/or orientation and during the movement of the robot 100 there is a simultaneous storage of a plurality of path data D(Xp, Yp, φp). The higher the data acquisition rate, the greater the definition precision of the perimeter 600.

Of the triad of coordinates of each of the points Xp, Yp, φp of the perimeter, the coordinates Xp and Yp represent the position on the plane of the working area 500; the coordinate φp identifies an orientation of the robot 100 on the azimuthal plane.

The method disclosed herein therefore comprises a step of storing a plurality of path data D(Xp, Yp, φp) in a non-volatile electronic memory, optionally in said electronic memory 300. The system disclosed herein is thus configured to store the plurality of path data D(Xp, Yp, φp) in a non-volatile auxiliary electronic memory, optionally in the electronic memory 300.

When the perimeter 600 of the working area 500 has been defined, there is a preliminary movement step (step 1006) of the robot 100 within the predetermined working area 500, along a second path which in FIG. 1 is identified by reference numeral 602.

Such a second path is defined by the user and, starting from the initial point 601, ends at the charging station 400. During the movement of the robot 100 along the second path 602 there is again a simultaneous storage of a plurality of path data D(Xp, Yp, φp) during the continuation of said preliminary movement (step 1006).

In the preliminary movement step there is therefore the storage of a destination datum D(Xf, Yf, φf) corresponding to a path end point Xf, Yf, φf in which the charging station 400 is located. There is therefore a step of identifying a path end point Xf, Yf, of identified by the block 1007 of FIG. 4. It is therefore clear that the system disclosed herein is configured to identify and store, at least temporarily, the coordinates of the path end point Xf, Yf, φf. In particular, the identifying and storing step may be executed by the data processing unit 104 of the robot 100.

Of the triad of coordinates of the path end point Xf, Yf, φf, the coordinates Xf and Yf represent the position on the plane of the working area 500; the coordinate of identifies an orientation of the robot 100 on the azimuthal plane.

In a preferred, but non-limiting embodiment, the destination datum comprises at least one azimuthal orientation angle of the charging station 400. This datum is useful to allow to understand whether the actual orientation of the robot 100 in the coordinate point Xf, Yf, is the same as the coupling portion 402 of the charging station 400, and therefore to understand whether or not there is a misalignment between the orientation of the robot 100 in such a point and the orientation of the coupling portion 402 in such a point.

It is therefore clear that ideally the coordinates Xf, Yf, φf of the path end point correspond to the coordinates X0, Y0, φ0 of the aforementioned predetermined point.

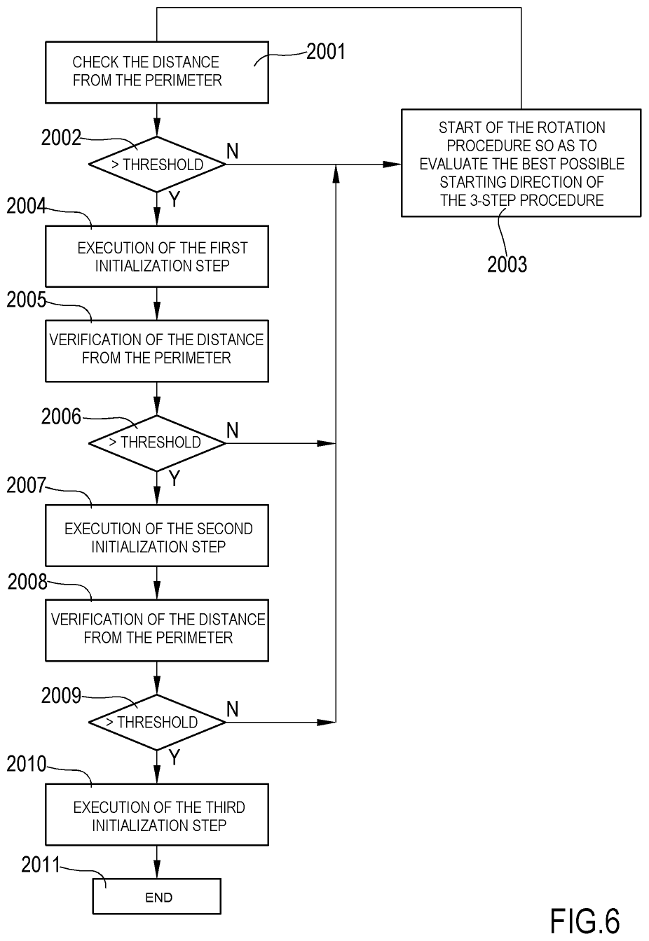

As schematically depicted in the block diagram of FIG. 6, there is an execution of three successive movement steps of the robot 100 which give rise to what is called “3-step”.

In particular, with reference to the block diagram of FIG. 6, downstream of the step of verifying the distance from the perimeter of the robot 100 (block 2001), if the second distance 70 is greater with respect to the first distance 70 and/or if the second distance 70 is greater than said threshold distance value (block 2002, output S), the robot 100 is moved along a direction A identified by the first rotation angle φ1 of the robot 100 on the azimuthal plane. For example, the robot 100 is linearly translated by 30 cm. This movement, in particular this linear translation, corresponds to the step referred to in block 2004 of the diagram of FIG. 6.

Subsequently (block 2005), a further (second) step of measuring the distance of the robot 100 from the perimeter 600 takes place. If the distance 70 of the robot from the perimeter 600 is greater with respect to the previous distance 70 which the robot assumed with respect to the perimeter and/or if the distance 70 is greater than said threshold distance value (block 2006, output S), the robot 100 is moved along a direction A identified by the first rotation angle φ1 of the robot 100 on the azimuthal plane. For example, the robot 100 is translated linearly by further 30 cm. This movement, in particular this linear translation, corresponds to the step referred to in block 2007 of the diagram of FIG. 6.

Subsequently (block 2008), a further (third) step of measuring the distance of the robot 100 from the perimeter 600 takes place. If the distance 70 of the robot from the perimeter 600 is greater with respect to the previous distance 70 which the robot assumed with respect to the perimeter and/or if the distance 70 is greater than said threshold distance value (block 2009, output S), the robot 100 is moved along a direction A identified by the first rotation angle φ1 of the robot 100 on the azimuthal plane. For example, the robot 100 is translated linearly by further 30 cm. This movement, in particular this linear translation, corresponds to the step referred to in block 2010 of the diagram of FIG. 6.

At this point the “3-step” process disclosed above ends, and it is possible to proceed with the start of the normal movement of the robot 100, and in particular it is possible to proceed with the start of the working operating configuration which has been previously disclosed in the present disclosure.

Otherwise, if in one of the checks of the distance of the robot 100 from the perimeter 600 of the working area 500 it is verified that the second distance 70 is less with respect to the first distance 70 and/or if the second distance 70 is less than said threshold distance value, or that even only the first distance 70 is less with respect to said threshold value (blocks 2002, 2006, 2009, output N), a rotation of the robot 100 is started which is such as to determine a distancing of the predefined point 103 with respect to the perimeter of the working area. The step of the three successive movements of the robot 100 then starts again (exit of the block 2003 of FIG. 6).

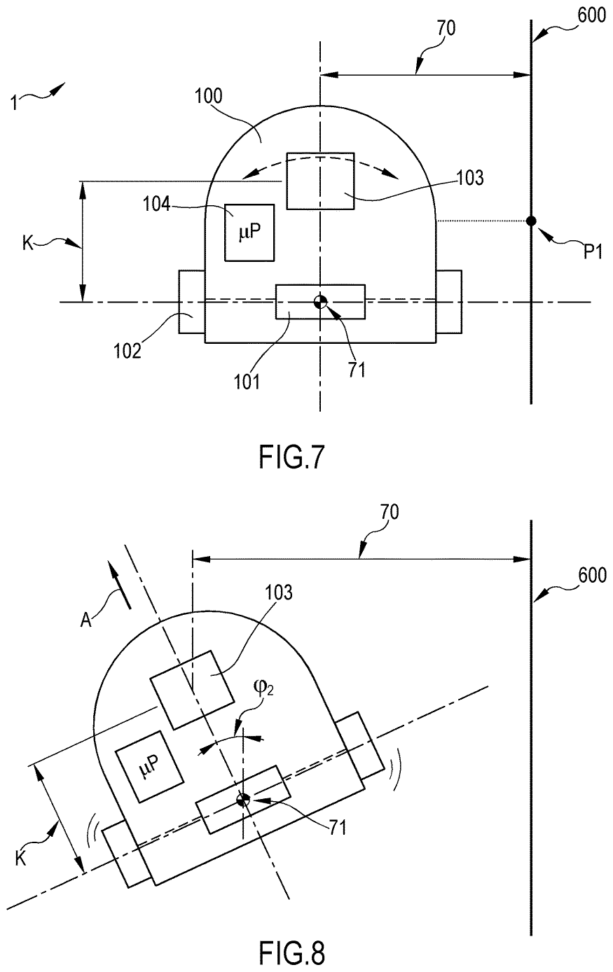

FIG. 7 and FIG. 8 clearly show how the rotation of the robot 100 occurs in the step disclosed above. In particular, FIG. 6 shows a first situation in which the robot 100 is arranged in a direction substantially parallel to a portion of the perimeter 600, and is located at a first distance with respect to a point P1 of the perimeter 600. Such a first distance 70 is measured orthogonally to the portion of perimeter closest to the predefined point 103 of the robot 100. The robot assumes, with respect to a predefined orientation direction, a first rotation angle φ1. Assuming the predefined orientation direction along the bottom-up direction of FIG. 7, the first rotation angle (φ1 is zero.

Following the counter-clockwise rotation, the robot 100 is located at a new distance 70 with respect to the point P1 of the perimeter; more precisely the predefined point 103 of the robot, which is taken as a reference for measuring the distance, is located at a new distance 70 with respect to the perimeter. This occurs because the rotation of the robot is a rotation which occurs on the axis which joins the wheels and/or tracks 102, in particular in the centre line of such an axis; the centre line is indicated in FIG. 7 as well as in FIG. 8 with the reference number 71.

Such an axis is located at a distance K with respect to the predefined point 103 of the robot. For this reason, in the mutual position configurations between the robot 100 and the perimeter 600 of FIG. 7 and FIG. 8, a clockwise rotation starting from the first rotation angle φ1 with respect to the reference direction will initially determine an approach of the robot 100 to the perimeter 600 (reduction of the distance 70); a counter-clockwise rotation starting from the first rotation angle φ1 with respect to the reference direction will initially determine a distancing of the robot 100 from the perimeter 600 (increase of the distance 70).

The “3-step” procedure comprises three successive steps precisely because the position and/or orientation of the robot 100 is disclosed on the basis of a triad of coordinates. The “3-step” procedure, in use, is completed in about 3-4 minutes, since each step of the aforesaid procedure typically takes about 1 minute to complete.

It is thus clear that the present disclosure illustrates a method which also comprises at least one distance measurement step (step 2001), in which, starting from a temporary position and/or orientation X, Y, φ of the robot 100 with respect to the predetermined positional reference 200 within the working area 500, a first distance 70 between the predefined point 103 of the robot 100 and a predefined point P1 on the perimeter 600 of the working area 500 is measured.

If the distance 70 is less than a threshold distance value 2002; 2006; 2009 with respect to the perimeter, the method comprises a rotation step (step 2003) of the robot 100 placing the predefined point 103 of the robot 100 at a second distance 70 with respect to the perimeter of the predetermined working area 500.

The rotation step (step 2003) is intended to determine a rotation of the robot 100 from a first rotation angle φ1 of the robot 100 on the azimuthal plane to a second rotation angle φ2 of the robot 100 on the azimuthal plane.

Downstream of the rotation step, if the second distance 70 is greater with respect to the first distance 70 and/or if the second distance 70 is greater than said threshold distance value 2002; 2006; 2009 with respect to the perimeter 600, the method object of the present disclosure includes a movement step 2004; 2007; 2010 of the robot along a direction A identified by the second rotation angle φ2 of the robot 100 on the azimuthal plane.

The method according to the present disclosure also comprises comprising a subsequent execution of at least one further electronic distance measurement step (block 2001), preferably a first and a second further distance measurement step (blocks 2005, 2008).

If the second distance 70 is greater with respect to the first distance 70 and/or if said second distance 70 is greater than the threshold distance value (blocks 2002; 2006; 2009), a subsequent execution of at least one further movement step (blocks 2007; 2010), preferably a first and a second further movement step (blocks 2007; 2010), to determine the predetermined point X0, Y0, φ0 of the predetermined working area 500, in particular to determine at least a first and a second distance coordinate with respect to the predetermined positional reference 200 and to determine an azimuthal orientation coordinate with respect to the predetermined positional reference 200.

In light of the above, it is therefore clear that the present disclosure illustrates a system for controlling the position and/or orientation of a robot 100, preferably a robot lawnmower, comprising:
the robot 100,
an electronic memory 300 on which a first position and/or orientation datum D (X0, Y0, φ0) of the robot 100 is stored (step 1000) when positioned in a predetermined point X0, Y0, φ0 of the working area 500 where a predetermined positional reference 200 is situated, and in which the electronic memory 300 is operatively accessible to the robot 100;
a data processing unit, configured to execute an electronic analysis (step 1001) of a need to impose or reset a datum D(X, Y, φ) of temporary position and/or orientation X, Y, φ of the robot 100 with respect to the predetermined positional reference 200.

The data processing unit is configured to electronically execute an electronic access (step 1002) to the electronic memory 300 and to subsequently extract, from said electronic memory 300, the first position and/or orientation datum D(X0, Y0, φ0).

The data processing unit is configured to carry out a reset (step 1003), comprising:
if the robot 100 is not at the predetermined positional reference 200, and/or the temporary position and/or orientation X, Y, φ of the robot 100 does not correspond to that of the predetermined positional reference 200, a movement control of the robot 100 to position it at the predetermined positional reference 200; and
a maintenance of the robot 100 at said predetermined positional reference 200, and a forcing of the datum D(X, Y, φ) of temporary position and/or orientation X, Y, φ of the robot 100 to the first position and/or orientation datum D(X0, Y0, φ0).

As already partially anticipated, in an embodiment the data processing unit comprises a data processing unit 104 of said robot and/or a data processing unit of a charging station 400.

Such a data processing unit may comprise a general purpose processor, or one or more Application-Specific Integrated Circuits (AISC) or an FPGA or PLC or equivalent computing unit capable of executing the operations disclosed in the present document. Where the processor is programmable, it will have firmware or hardware designed to make it possible to execute the disclosed method.

The predetermined point X0, Y0, φ0 is a point where the charging station 400 for the robot 100 is present and/or where the predetermined positional reference 200 corresponds to the charging station 400 or is a point situated at a predefined distance with respect to the charging station 400.

In use, the robot 100, and in particular the data processing unit, is configured to electronically access said electronic memory 300.

The reset (step 1003) determines a storage of said first position and/or orientation datum D(X0, Y0, φ0) as datum D(X, Y, φ) of temporary position and/or orientation of the robot 100.

The robot 100 and, preferably, the system, is configured to electronically identify the robot 100 reaching the charging station 400, when a coupling is verified between electrical and/or magnetic contacts of the charging station 400 with electrical and/or magnetic contacts of said robot 100.

Therefore, the system or the robot 100 in particular is configured to electronically identify the robot 100 reaching the predetermined positional reference 200 when a physical interaction occurs between the predetermined positional reference 200 and the robot 100;

The system is configured to identify having reached the predetermined positional reference 200 and/or of the charging station 400 by determining, and in particular causing a storage of an alteration of an operating state of the robot 100.

The data processing unit is configured to determine a movement 1004 of the robot 100 within the working area 500, and to cause, be means of the movement, an alteration of the datum D(X, Y, φ) of temporary position and/or orientation X, Y, φ of the robot 100. The methods in which the alteration takes place have already been disclosed and therefore are not repeated.

The present disclosure also relates to a specific method for controlling the position of a robot 100, in particular a robot lawnmower, designed to address the problem which the Applicant has identified where it is necessary to perform a “3-step” procedure efficiently when the robot 100 is near the perimeter 600 of the working area, which allows to reduce the risk of meeting and exceeding the limit of the working area during the straight line advancement necessary in a traditional “3-step” procedure. Such a specific control method is disclosed independently of the above-disclosed forcing of the position of the robot 100.

The method disclosed in the present disclosure (refer in particular to FIG. 6) firstly comprises a distance measurement step (block 2001), in which, starting from a temporary position and/or orientation X, Y, (of the robot 100 with respect to a predetermined reference 200 within the working area 500, a first distance 70 is measured between a predefined point 103 of the robot 100 and a predefined point P1 on the perimeter 600 of the working area 500.

If the first distance 70 is less than a threshold distance value (blocks 2002; 2006; 2009) with respect to the perimeter 600, and in particular to the point P1 of the perimeter 600, the method comprises a rotation step (block 2003) of the robot 100, placing the predefined point 103 of the robot 100 at a second distance 70 with respect to the perimeter 600, and in particular at the second distance 70 with respect to the point P1 of the perimeter 600 of the working area 500.

From the viewpoint of the physical actuation of devices on the robot 100, the rotation step (block 2003) comprises an actuation of the movement motor unit 101 of the robot 100, which acts on the wheels and/or rollers and/or tracks 102 and determines a rotation from a first rotation angle φ1 of the robot 100 on the azimuthal plane to the second rotation angle φ2 of the robot 100 on the azimuthal plane.

In particular, the predefined point P1 on the perimeter 600 of the predetermined working area 500 is a point P1 at a minimum distance with respect to the predefined point 103 of the robot 100.

The first distance 70 between the predefined point 103 of the robot 100 and the predefined point P1 is a distance calculated on a direction orthogonal to a local tangent at said predefined point P1 of said perimeter 600. Such a direction joins with the predefined point 103 of the robot 100.

If the second distance 70 is greater with respect to the first distance 70 and/or if the second distance 70 is greater than the threshold distance value (blocks 2002; 2006; 2009) with respect to the perimeter 600, the method comprises a movement step (blocks 2004; 2007; 2010) of the robot 100 along a direction A identified by the second rotation angle φ2 of the robot 100 on the azimuthal plane. It is therefore clear that the movement of the robot 100 is a movement which, except for unintentional variations, is substantially axial.

The movement step (block 2004; 2007; 2010) ends automatically when the robot 100 has travelled at least a predefined translation distance. In a non-limiting embodiment, the translation is at least equal to 20 cm, or 30 cm, or 40 cm, or 50 cm.

As already partially disclosed, the rotation is centred on a predefined rotation point 71 of the robot 100 which is placed at a predetermined and non-zero distance K with respect to the predefined point 103.

So as to optimize the movement and/or rotation precision of the robot 100, the predefined point 103 of the robot 100 comprises at least one among an antenna configured to receive a positioning signal of the robot 100, /or a unit for receiving a positioning signal of the robot 100.

In an embodiment, the satellite antenna is positioned in the predefined point 103 which receives, in use, the positioning signal which comprises positioning data for the robot 100. The satellite positioning signal comes from the external positioning system 800 and/or the second positioning system.

Therefore, during the movement (blocks 2004; 2007; 2010) of the robot 100 along the direction A there is a linear translation for a predefined translation distance which, preferably, is determined by the positioning signal and which, in particular, is stopped in accordance with reaching a predefined translation length—along the direction A—determined by the positioning signal. Downstream of the movement, a further distance measurement step is executed (block 2001).

It is therefore clear that in use, in the distance measurement step (block 2001) there is a reception of said positioning signal, in particular of the satellite positioning signal, of the robot 100, which determines a reception of at least one datum D(X, Y, φ) of temporary position and/or orientation X, Y, φ of the robot 100.

It should be noted in particular that in the distance measurement step (block 2001) it comprises a calculation of said first distance 70 and said second distance 70 by means of the positioning signal, the datum D(X, Y, φ) of temporary position and/or orientation X, Y, φ of the robot 100 is updated at least when the robot 100 lies at the second distance 70.

In a particular embodiment, the movement step (2004; 2007; 2010) of the robot 100 along the direction A comprises an electronic calculation of the distance travelled by the robot 100 by means of an inertial or kinematic calculation system associated with the wheels and/or rollers and/or tracks 102 and/or comprises an electronic calculation of a distance travelled by the robot 100 by means of the positioning signal received from the antenna and/or receiving unit of a positioning signal.

The Applicant has observed that the rotation of the robot from the first rotation angle φ1 to the second rotation angle φ2 could be insufficient to place the predefined point 130 of the robot 100 at a distance greater than said threshold distance value with respect to the perimeter 600 of the working area 500 and, more in particular, with respect to the point P1 of the perimeter 600.

For this reason, if the second distance 70 is smaller with respect to the first distance 70 and/or if the second distance 70 is smaller than the threshold distance value (blocks 2002; 2006; 2009) with respect to the perimeter 600, and more in particular, with respect to the point P1 of the perimeter 600, the method object of the present disclosure comprises a rotation of the robot 100 from the second rotation angle φ2 on the azimuthal plane to at least one further rotation angle φ3 of the robot 100 on the azimuthal plane. When the robot 100 has reached the third rotation angle φ3, the method comprises a further distance measurement step (block 2001).

It is clearly understood that for the purposes of the present disclosure, the first rotation angle φ1 and/or the second rotation angle φ2 and/or the third rotation angle φ3 is defined with respect to a predefined and constant reference direction.

By way of non-limiting example, between the first rotation angle φ1 and the second rotation angle φ2 and/or between the second rotation angle φ2 and the third rotation angle φ3 there is a rotation of at least less than 15°, or less than 10°, or less than 5°, or a rotation of at least 50°, preferably at least 70°, more preferably at least 90°.

In some given cases, the shape of the working area 500 can be very particular and such as to determine that not even following the rotation of the robot 100 to reach the third rotation angle φ3, the distance of the robot 100 from the perimeter, and in particular from the predefined point P1 of the perimeter, is greater than the threshold distance value. In this case, if following the rotation of the robot 100 from the second rotation angle φ2 on the azimuthal plane to at least one further rotation angle φ3 on the azimuthal plane or if following a complete rotation of said robot on said azimuthal plane, the distance of the robot 100 from the perimeter 600, in particular from the predefined point P1 of the perimeter 600, is always smaller with respect to the threshold distance value (mouths 2002; 2006; 2009), the method comprises at least one among the following steps:
stopping the robot 100;
transmitting an alarm signal; and
defining and/or storing a threshold distance value lower than the previous one.

This particular function of the method is particularly useful where it is necessary to rotate the robot 100 over particularly narrow and long zones of the working area 500.

So as to search for an optimal search for the most optimal rotation position for the robot 100 without falling below the threshold distance value from the perimeter 600 and without requiring a premature transmission of said alarm signal and/or a storage of a threshold distance value lower than the previous rotation from the second rotation angle φ2 to the third rotation angle φ3 and the rotation from the first rotation angle φ1 to the second rotation angle φ2 take place in the same direction; alternatively, the rotation from the second rotation angle φ2 to the third rotation angle φ3 takes place in an opposite direction with respect to the rotation direction from the first rotation angle φ1 to the second rotation angle φ2.

In the method disclosed herein there may be an electronic calculation step of a difference between the distance travelled by the robot 100 calculated by means of said inertial or kinematic calculation system and the distance travelled by the robot 100 by means of the positioning signal received from said antenna and/or unit for receiving a positioning signal, and/or by means of the external positioning system 800 and/or by means of the second positioning system.

Preferably, the aforementioned electronic calculation is executed by the data processing unit 104 of the robot 100. When said difference is greater in absolute value with respect to a predetermined critical difference threshold, an alarm signal is transmitted.

Such an alarm signal, of an electronic and/or visual and/or audible type, is aimed at the user of the robot 100, and is aimed at allowing the execution of a reset procedure of the position of the robot 100 as disclosed above.

A specific embodiment of the method according to the present disclosure first comprises at least a first distance measurement step (block 2001), in which, starting from a temporary position and/or orientation X, Y, φof the robot 100 with respect to a predetermined reference 200 within the working area 500, a first distance 70 between a predefined point 103 of the robot 100 and a predefined point P1 on the perimeter 600 of the working area 500 is measured.

If the first distance 70 is less than a threshold distance value (block 2002; 2006; 2009) with respect to the perimeter 600, the method comprises a rotation step (block 2003) of the robot 100. In the aforesaid rotation step, the predefined point 103 of the robot 100, placed at a predefined and non-zero distance K with respect to a predefined rotation point 71 of said robot 100, is placed at a second distance 70 with respect to the perimeter 600 of the working area 500.

The rotation step (block 2003) comprises a rotation from a first rotation angle φ1 on an azimuthal plane to a second rotation angle φ2 on the azimuthal plane.

In light of the three paragraphs disclosed above, it is clear that the present disclosure concerns a specific embodiment of a robot 100, in particular a robot lawnmower, which comprises:
a movement motor unit 101;
wheels and/or rollers and/or tracks 102, connected to said movement motor unit 101 and configured to determine a movement of the robot 100;
a data processing unit 104, configured to perform at least a first electronic measurement (block 2001) of a distance between a temporary position and/or orientation X, Y, φ of the robot 100 with respect to a predetermined reference 200 within the working area 500 and determine a first distance 70 between a predefined point 103 of the robot 100 and a predefined point P1 on the perimeter 600 of the working area (500).

The robot 100 is configured to rotate on itself at a rotation point 71 placed at a predefined and non-zero distance with respect to said predefined point 103, and the data processing unit 104 is configured to calculate a difference between the first distance 70 and a threshold distance value (blocks 2002; 2006; 2009).

Such a threshold distance value may generally be set to be representative of the distance of the robot 100 with respect to the perimeter 600. However, the threshold distance value may alternatively be set. For example, the threshold distance value may be greater than the distance of the robot 100 with respect to the perimeter 600 (being in particular calculated by multiplying the distance of the robot 100 with respect to the perimeter 600 with a coefficient greater than 1), so as to obtain a more secure control of the position of the robot 100.

If the distance 70 is less than a threshold distance value (block 2002; 2006; 2009), in particular with respect to the perimeter 600, the data processing unit 104 is configured to drive the movement motor unit 101 so as to determine, by means of said wheels and/or rollers and/or tracks 102, a rotation of the robot 100 and to determine, by means of the rotation, a displacement of the predefined point 103 of the robot 100 at a second distance 70 with respect to said perimeter 600 of the predetermined working area 500.

The rotation which the movement motor unit 101 imposes on the body of the robot 100, determines a movement thereof from a first rotation angle φ1 on an azimuthal plane to a second rotation angle φ2 on the azimuthal plane.

It is foreseeable that during the movement in rotation from the first rotation angle φ1 on the azimuthal plane to the second rotation angle φ2 on the azimuthal plane, the working operating configuration can be kept active; in an alternative embodiment, it is foreseeable that during the movement in rotation from the first rotation angle φ1 on the azimuthal plane to the second rotation angle φ2 on the azimuthal plane, the working operating configuration is deactivated. The deactivation of the working operating configuration is preferably automatically performed by the data processing unit 104 of the robot 100, without user intervention.

Clearly, the rotation step (block 2003) comprises an actuation of the movement motor unit 101 of the robot 100 acting on its wheels and/or rollers and/or tracks 102. In particular, the rotation step disclosed herein comprises an actuation of the first movement motor and the second movement motor in counter-rotation with respect to each other, so as to allow the rotation of the robot 100 on itself.

Even in the case of the specific embodiment of the method and equivalent configuration of the robot 100 disclosed above, if the second distance 70 is smaller with respect to the first distance 70 and/or if the second distance 70 is smaller than the threshold distance value (block 2002; 2006; 2009) with respect to the perimeter 600, the method comprises rotating the robot 100 from the second rotation angle φ2 to at least one further rotation angle φ3. At this point, the method includes a new and further distance measurement step (block 2001).

It is foreseeable that during the movement in rotation from the second rotation angle φ2 on the azimuthal plane to the third rotation angle φ3 on the azimuthal plane, the working operating configuration can be kept active; in an alternative embodiment, it is foreseeable that during the movement in rotation from the second rotation angle φ2 on the azimuthal plane to the third rotation angle φ3 on the azimuthal plane, the working operating configuration is deactivated. The deactivation of the working operating configuration is preferably automatically performed by the data processing unit 104 of the robot 100, without user intervention.

In a specific embodiment, if the second distance 70 is smaller with respect to the first distance 70 and/or if the second distance 70 is smaller with respect to the threshold distance value (block 2002; 2006; 2009), the rotation (block 2003) determines a progressive rotation of the robot 100 around the rotation point 71 and the method comprises the execution of at least one further, preferably a plurality of, distance measurement step(s) 2001.

The progressive rotation imposed on the robot 100 by the movement motor unit 101 ends when at least in a further, or one of the further, distance measurement step(s) (block 2001), it is electronically measured that the second distance 70 is greater with respect to the first distance 70 and/or if the second distance 70 is greater than the threshold distance value (block 2002; 2006; 2009) with respect to the perimeter 600.

The progressive rotation imposed on the robot 100 by the movement motor unit is such as to determine a maximum rotation of the robot 100 of 360° on the azimuthal plane; in other words, between the first rotation angle φ1 and the second rotation angle φ2 and/or the further (third) rotation angle φ3 there is a maximum rotation of 360° on the azimuthal plane. When the robot has rotated 360° on the azimuthal plane without the predetermined point 103 being at a distance greater than the threshold distance value from the point P1 of the perimeter 600, this means that there is no way to overcome the lack of safety distance from the edge of the perimeter without actuating an alternative problem-solving procedure.

In the specific embodiment disclosed herein, when following the rotation, the second rotation angle (2 and/or the further rotation angle φ3 again coincides with the first rotation angle (1) and/or when the progressive rotation has determined a rotation of the robot 100 of 360° on the azimuthal plane without the second distance 70 ever reaching a value equal to or greater than said threshold distance value (block 2002, 2006, 2009), the method comprises a step of stopping the robot 100, and optionally an alarm signal is transmitted.

In a specific embodiment, the alarm signal is an electronic alarm signal and the method comprises a step of transmitting the electronic alarm signal from the robot 100 to a predetermined portable electronic device, operatively and optionally uniquely, associated with the robot 100, and/or the method comprises a step of transmitting the electronic alarm signal from the robot 100 to a charging base 400 of the robot 100.

The predetermined portable electronic device may be a mobile phone or a tablet of the user, possibly on which a software program interfacing with the system disclosed herein and, in particular with the robot 100, is installed, or may be a dedicated electronic device, forming part of the system itself. Such a dedicated electronic device may in particular be a remote control provided with a control monitor or, in any case, with a user interface adapted to receive the alarm signal.

In a further non-limiting embodiment, the alarm signal can be a visual and/or sound signal directly emitted by the robot 100.

The threshold distance value must not be understood as necessarily, and therefore limitedly, fixed; in fact, the threshold distance value can be electronically modified by the robot 100 and/or as a result of a command imposed by the robot 100.

In a non-limiting embodiment, when following the rotation of the robot 100 the second rotation angle 92 and/or the further rotation angle φ3 again coincides with the first rotation angle φ1, and/or when the progressive rotation has determined a rotation of said robot 100 of 360° on the azimuthal plane without said second distance 70 ever reaching a value equal to or greater than the threshold distance value (block 2002, 2006, 2009), the method may comprise:
an electronic modification of the threshold distance value (block 2002; 2006; 2009), in which the threshold distance value is reduced by a predetermined amount,
following said electronic modification, the automatic execution of at least one further rotation step 2003.

Simplifying, therefore, an attempt is made to reduce the distance threshold with respect to the perimeter 600 to verify if, by doing so, it is possible to make the robot 100 carry out the aforementioned “3-step” process. If this is successful, although with a lower tolerance, it is possible to return the robot 100 to the execution of its traditional task (for example, mowing the lawn), without the need for manual intervention by the user.

Clearly, the embodiment of the method disclosed above is equivalent to a suitable configuration of the robot 100, in particular made possible by the programming of the data processing unit 104, which is not disclosed below, since it can be directly deduced from the steps of the method disclosed above.

In an alternative solution, where as a result of the 360° rotation of the robot 100, it is not possible to determine the positioning of the predetermined point 103 at a sufficient distance to the threshold distance value, an attempt is made to reverse the robot 100 over its own steps. In such a case, more specifically, when the second rotation angle φ2 and/or the further rotation angle φ3 again coincides with the first rotation angle φ1, and/or when the progressive rotation has determined a rotation of the robot 100 of 360° on the azimuthal plane without the second distance 70 ever reaching a value equal to or greater than the threshold distance value (2002, 2006, 2009), the method comprises:
if necessary, a rotation step of the robot 100 around the rotation point 71, to bring the robot 100 back to correspond to the first rotation angle φ1, which is supposed to be the direction in which the robot was originally oriented;
a translation step of the robot 100 at a predefined reference position within the working area 500. The predefined reference position is a position previously assumed by the robot 100.

In a non-limiting embodiment, during the aforementioned translation step, the data processing unit 104 of the robot 100 can be configured to maintain the working operating configuration active. Otherwise, in an alternative embodiment, the data processing unit 104 of the robot 100 may be configured to deactivate, or to keep deactivated, the working operating configuration.

Clearly, the translation step occurs following the rotation step to return the robot 100 at said first rotation angle φ1, if executed.

The translation step is preferably a linear translation step and/or in which said predefined reference position is a position assumed by the robot 100 prior to said first distance measurement step (block 2001).

The translation step of the robot 100 at the predefined reference position is a step taking place at at least a predefined portion of the working area 500 characterized by an elongated and narrow shape with respect to at least one dimension of the robot 100 on the azimuthal plane.

In a further embodiment, when following the rotation of the robot 100 the second rotation angle φ2 and/or the further rotation angle φ3 again coincides with the first rotation angle φ1, and/or when the progressive rotation has determined a rotation of said robot 100 of 360° on the azimuthal plane without said second distance 70 ever reaching a value equal to or greater than the threshold distance value, the method comprises:
an electronic identification step of the rotation angle omax of the robot 100 on the azimuthal plane at which the predefined point 103 of the robot 100 is placed at a maximum distance with respect to the perimeter 600, optionally with respect to the predetermined point 601 on the perimeter 600, and
subsequently, a movement step (block 2004; 2007; 2010), which ends automatically when the robot 100 has travelled at least a predefined translation distance.

As previously disclosed, the translation step occurs along a predetermined linear direction identified by the rotation angle omax previously mentioned. For the purposes of the present disclosure, the rotation angle omax may be defined as the auxiliary rotation angle.

The step of identifying the rotation angle omax of the robot 100 on the azimuthal plane clearly follows a temporary storage on an electronic memory, in particular on the electronic memory 300, of a plurality of pairs [rotation angle φr; distance D]. The data processing unit of the robot 100 can conveniently be programmed to perform said storage in an automated manner. For example, following a rotation of the robot 100 on the azimuthal plane for a given arc of circumference, by way of non-limiting example the entire circumference (360°), a set of N pairs [rotation angle φr; distance D] is stored: from [rotation angle φr1; distance D1] to [rotation angle φrN; distance DN].

The step of identifying the rotation angle omax of the robot 100 on the azimuthal plane comprises an electronic scan of the entire set [rotation angle φr1; distance D1]-[rotation angle φN; distance DN] of pairs [rotation angle φr; distance D], to search for the maximum distance value DMAX. Such a set is therefore an electronic dataset.

The rotation angle φr corresponding to the pair whose distance D is said maximum distance value DMAX is selected electronically, which becomes omax and, if necessary, the movement motor unit 101 is activated automatically by the data processing unit of the robot 100 to cause a rotation of the robot 100 on itself, so as to place it in the orientation corresponding to the rotation angle φmax. At this point, the movement motor unit 101 is automatically activated by the data processing unit of the robot 100 to cause the linear translation of the robot for the predefined movement distance, in particular for the predefined linear translation distance.

It should be noted that in the execution of the 3-step process disclosed herein, it is possible that a rotation step of the robot 100, by way of non-limiting example between the first rotation angle φ1 and the second rotation angle φ2, or between the second rotation angle φ2 and the further rotation angle φ3, or the aforementioned progressive rotation, places the robot 100 in an orientation substantially 180° with respect to the orientation previously assumed on the azimuthal plane.

Although the present disclosure does not exclude the possibility that the movement step subsequent to the aforementioned rotation step takes place for a translation distance equal to the translation distance prior to the rotation step, in an embodiment the translation distance of the robot 100 downstream of a rotation of 180° on the azimuthal plane is different (greater, or smaller) with respect to the translation distance of the robot 100 immediately prior to the aforesaid rotation of 180°. Thanks to the implementation of this technical feature, the robot 100, during the 3-step process, is never found twice in the same point of the predetermined working area, and this allows to improve the positioning precision of the robot 100 itself.

The data processing unit of the robot 100, and/or—for the purposes of the present disclosure—the system, is clearly configured to electronically identify the case in which the rotation step of the robot 100 on the azimuthal plane determines a rotation of the robot 100 of 180°: if so, the data processing unit, and/or the system, is configured to force a translation distance of the robot 100, along the direction identified by the new rotation angle, different (greater, or smaller) with respect to the translation distance of the robot 100 along the orientation previously assumed.

The invention is not limited to the embodiments of the appended figures; this means that where in the claims certain steps of the method or features of the robot 100 and/or of the system are followed by reference numerals or signs, such reference numerals or signs are provided for the sole purpose of increasing the intelligibility of the claims and are not limiting.

It is finally evident that variations or additions, which are obvious to a person skilled in the art, may be applied to the object of the present invention, without departing from the scope of protection provided by the appended claims.

1.-73. (canceled)

74. A robot lawnmower configured to execute land maintenance operations within a working area delimited by a perimeter, wherein said robot lawnmower comprises:
a movement unit acting on wheels, rollers, or tracks of said robot lawnmower, said movement unit being configured to selectively determine a variation of position of said robot lawnmower or a variation of orientation of said robot lawnmower, said variation of orientation being obtained by a rotation of said robot lawnmower around a predefined axis orthogonal to the ground;
a primary sensor configured to detect the position of said robot lawnmower; and
a controller programmed to, starting from an initial position of said robot lawnmower in said working area and starting from an initial orientation of said robot lawnmower:
measure via the primary sensor a separation distance between a predefined point of said robot lawnmower and said perimeter of said working area, said predefined point of said robot lawnmower being placed at a non-zero distance with respect to said predefined axis, and preceding said predefined axis in the advancement direction of said robot lawnmower,
compare said separation distance to a distance threshold, and
actuate said movement unit of said robot lawnmower to determine:
if said separation distance is less than said threshold, rotate said robot lawnmower around said predefined axis and in a predefined rotation direction to vary the orientation of said robot lawnmower from a first orientation to a second orientation to establish a potential condition of increased distance of said predefined point of said robot lawnmower from said perimeter, or
if said separation distance is equal to or greater than said threshold, advance said robot lawnmower by a distance corresponding to said threshold to vary the position of said robot within said working area from a first position to a second position.

75. The robot lawnmower of claim 74, wherein said controller is further programmed to, if said rotation step is executed a number of times such as to determine, with respect to said initial orientation, a variation in orientation of said robot lawnmower equal to or greater than one turn angle, without a separation distance equal to or greater than said predefined value ever being measured, said robot lawn mower is stopped.

76. The robot lawnmower of claim 74, wherein said controller is further programmed to if said rotation step is executed a number of times such as to determine, with respect to said initial orientation, a variation in orientation of said robot lawnmower equal to or greater than one turn angle, without a separation distance equal to or greater than said predefined value ever being measured, said controller is further programmed to iteratively repeat measuring the said separation distance, comparing said separation distance to a distance threshold, and actuating said movement unit of said robot lawnmower, adopting for each repetition an adjusted distance threshold of lesser value with respect to the value of the distance threshold adopted in the previous repetition, and wherein said robot lawnmower is stopped, if:
said procedure is repeated a number of times such as to reach a critical number of repetitions, or
said distance threshold is reduced until a critical distance threshold is reached.

77. The robot lawnmower of claim 74, wherein said controller is further programmed to, if said rotation step is executed a number of times such as to determine, with respect to said initial orientation, a variation in orientation of said robot lawnmower equal to or greater than one turn angle, without a separation distance equal to or greater than said predefined value ever being measured, said controller is further programmed to:
arrange said robot lawnmower in the orientation at which the maximum distance between said predefined point of said robot lawnmower and said perimeter has been measured and
advance said robot lawnmower by a predefined distance, said predefined distance preferably being less than said distance threshold.

78. The robot lawnmower of claim 74, wherein the controller is further programmed to subject said robot lawnmower to a predefined rotation upon the completion of said advancement step.

79. The robot lawnmower of claim 74, wherein said distance threshold is calculated taking into account the shape or criticality of the perimeter section near which said robot lawnmower is positioned, where said criticality is representative of the deemed danger of a possible encroachment of said robot lawnmower from said working area through said perimeter section.

80. The robot lawnmower of claim 74, wherein said predefined point of said robot lawnmower corresponds to the installation point of said primary sensor in said robot lawnmower, wherein said robot lawnmower comprises at least one secondary sensor configured to detect the position or the orientation of said robot lawnmower in said working area and wherein said advancement step comprises a calibration of said at least one secondary sensor by said primary sensor,
wherein said primary sensor is a satellite-type position detector, in particular a detector according to GPS technology, or wherein said at least one secondary sensor is an inertial-type position detector, in particular an accelerometer, gyroscope, or a magnetometer.

81. The robot lawnmower of claim 74, wherein said controller is further programmed to measure the said separation distance, compare said separation distance to a distance threshold, and actuate said movement unit of said robot lawnmower:
during the installation of said robot lawnmower in said working area, or
during the operation of said robot lawnmower, if the uncertainty in the detection of the position of said robot lawnmower by said primary sensor or said at least one secondary sensor exceeds a tolerance threshold.

82. A method for controlling the position of a robot lawnmower, comprising:
measuring, when starting from a temporary position or orientation of said robot with respect to a predetermined reference within a predetermined working area, a first distance between a predefined point of said robot and a perimeter of said predetermined working area; and
rotating the robot if said first distance is less than a threshold distance value, placing said predefined point of said robot at a second distance with respect to said perimeter of said predetermined working area, said rotating comprising an actuation of a movement motor unit of the robot acting on wheels, roller, or tracks of said robot and determining a rotation from a first rotation angle of said robot on an azimuthal plane to a second rotation angle of said robot on the azimuthal plane,
wherein said rotating is centred on a predefined rotation point of said robot placed at a predetermined and non-zero distance with respect to said predefined point of the robot.

83. The method of claim 82, wherein the first distance and the second distance with respect to said perimeter are distances with respect to a predefined point on the perimeter, wherein the predefined point on the perimeter of said predetermined working area is a point at a minimum distance with respect to said predefined point of said robot and wherein the first distance and the second distance between the predefined point of said robot and the predefined point are distances calculated in a direction orthogonal to a local tangent to said predefined point of said perimeter.

84. The method of claim 82, wherein when the second distance is greater than the first distance or when said second distance is greater than said threshold distance value, the method further comprises moving of said robot along a direction identified by said second rotation angle of said robot on an azimuthal plane, said moving of said robot automatically ending when the robot has travelled at least one predefined translation distance.

85. The method of claim 84, wherein said predefined point of the robot comprises at least one among an antenna configured to receive a satellite positioning signal of the robot or a unit for receiving a positioning signal of the robot, wherein the positioning signal comprises positioning data transmitted to said robot by an external positioning system, and
wherein said measuring comprises a reception of said satellite positioning signal of said robot, the reception of said positioning signal determining a reception of at least one datum of temporary position or orientation of said robot, said measuring comprising a calculation of said first distance and of said second distance by said positioning signal, said datum of temporary position or orientation of said robot being updated at least when said robot lies at said second distance.

86. The method of claim 85, wherein the moving of said robot along the direction comprises a linear translation for a predefined translation distance, and is followed by measuring a further distance.

87. The method of claim 85, wherein the moving of said robot along a direction comprises an electronic calculation of a distance travelled by said robot by:
an inertial or kinematic calculation system associated with said wheels, tracks, or rollers, or
the positioning signal received from said antenna or said unit for receiving the positioning signal.

88. The method of claim 82, wherein when the second distance is smaller than the first distance or when said second distance is smaller than said threshold distance value, the method comprises a rotation of said robot from said second rotation angle of said robot on an azimuthal plane to at least one further rotation angle of said robot on the azimuthal plane, the method subsequently comprising measuring a further distance.

89. The method of claim 82, wherein, if, following said rotation of said robot from said second rotation angle of said robot on an azimuthal plane to at least one further rotation angle of said robot on the azimuthal plane or if, following a complete rotation of said robot on said azimuthal plane, the distance of the robot from said perimeter is less than said threshold distance value, the method further comprises:
stopping said robot, or
defining or storing an updated threshold distance value smaller than said threshold distance value.

90. A method for controlling the position or orientation of a robot lawnmower, comprising:
storing a first position or a first orientation datum of said robot electronically in an electronic memory, said robot being positioned at a predetermined point of a predetermined working area, the predetermined point being the point of a predetermined positional reference for said robot;
analysing a need to impose or reset a datum of a temporary position or a temporary orientation of said robot with respect to said predetermined positional reference; and
accessing said electronic memory and extracting from said electronic memory said first position or first orientation datum, and
resetting, when keeping the robot at said positional reference, the datum of said temporary position or said temporary orientation of said robot to correspond with said first position or first orientation datum,
wherein the predetermined positional reference corresponds to a charging station, said charging station having a known position or orientation, and
wherein the operation of the robot in movement to be positioned at said predetermined positional reference comprises the robot reaching the charging station, and is determined by a coupling between electrical contacts of the charging station with electrical contacts of said robot.

91. The method of claim 90, wherein, during said resetting, if the robot is not at said predetermined positional reference, or the temporary position or temporary orientation of said robot does not correspond to that of the predetermined positional reference, moving the robot to be positioned at said predetermined positional reference, wherein said accessing said electronic memory is executed by said robot, and wherein said resetting determines a storage of said first position or first orientation datum as said temporary position or said temporary orientation datum of said robot.

92. The method of claim 90, further comprising determining a perimeter of said predetermined working area, wherein determining the perimeter comprises moving the robot along a first path defined by the user starting from an initial point in which said robot assumes a known position or a known orientation and comprises a simultaneous storage of a plurality of path data during the continuation of said movement, and storing said plurality of path data in a non-volatile electronic memory, optionally in said electronic memory.

93. The method of claim 90, further comprising a preliminary movement step of the robot within said predetermined working area, along a second path defined by the user and starting from an initial point towards said charging station and a simultaneous storage of a plurality of path data during the continuation of said preliminary movement, and storing at least one destination datum corresponding to a path end point in which said charging station is located, wherein said destination datum comprises at least one azimuthal orientation angle of said charging station, and wherein said path end point corresponds to said predetermined point.
